(19) United States
(12) Patent Application Publication
(10) Pub. No.: US 2024/0251809 A1
(43) Pub. Date: Aug. 1, 2024

(54) DAIRY PRODUCT AND PROCESS

(71) Applicant: Fonterra Co-Operative Group Limited, Auckland (NZ)

(72) Inventors: Caroline Lloyd Campbell, Auckland (NZ); Lisa Marie Rutherford, Auckland (NZ); Alice Matgorzata Smialowska, Auckland (NZ)

(21) Appl. No.: 18/564,539

(22) PCT Filed: May 25, 2022
(86) PCT No.: PCT/IB2022/054866

§ 371 Date: Nov. 27, 2023

(30) Foreign Application Priority Data
May 28, 2021 (AU) 2021901612
Dec. 2, 2021 (AU) 2021903902

(51) Int. Cl. A23C 9/15

(52) U.S. Cl. CPC A23C 9/1512

(57) ABSTRACT

The present invention relates to milk protein compositions and methods for their preparation and use. In particular, the invention relates to use of the milk protein compositions to prepare low viscosity and/or low firmness, high protein food products including yoghurts.

### FIELD OF THE INVENTION

The present invention relates to milk protein compositions and methods for their preparation and use. In particular, the invention relates to use of the milk protein compositions to prepare low viscosity, high protein food products including yoghurts.

### BACKGROUND TO THE INVENTION

High-protein foods, such as dairy, sports and medical beverages or cultured products or cheese, can be made by adding an ingredient with a high-protein content to a milk base or to some other composition. Desirable properties of a high-protein dairy ingredient include:
a bland, milky flavour,
a high concentration of protein,
heat stability,
high nutritional value, and/or
ease of mixing with the rest of the ingredients in the high protein food.

High-protein dairy ingredients include milk protein concentrates and isolates, whey protein concentrates and isolates, and caseinates.

For certain applications, it is desirable that the high-protein dairy ingredient provides a high protein content while achieving a low viscosity in the high protein food. Frequently, the use of high-protein dairy ingredients results in an unacceptably high viscosity in the food product. The use of microparticulated whey protein ingredients may achieve low viscosity in food products; however, while they do achieve the desired sensory properties, they do not provide the same casein:whey ratio of milk, can have strong protein or musty flavour profiles, and are more costly.

There is therefore a need for alternative dairy protein ingredients that have a high-protein content and that achieve a low viscosity and clean flavour when used to produce food products.

It is an object of the present invention to provide improved or alternative milk protein compositions, methods for their preparation and/or high protein foods comprising the milk protein compositions and/or to at least provide the public with a useful choice.

### SUMMARY OF THE INVENTION

In one aspect the invention generally provides a milk protein composition comprising milk protein, wherein
a) the composition comprises at least about 40% by weight total protein relative to the dry matter in the composition,
b) the milk protein comprises casein,
c) the total milk protein comprises less than about 79% by weight of peptides having a molecular weight of greater than about 20 kDa, and
d) the composition comprises
   i. less than about 2 g calcium per 100 g total protein, and/or
   ii. less than about 1.4 g calcium per 100 g of the dry matter in the composition.

In one aspect the invention provides a milk protein composition comprising a milk protein concentrate, or a milk protein isolate, or a combination thereof, wherein
a) the composition comprises at least about 40% by weight total protein relative to the dry matter in the composition,
b) the total milk protein comprises less than about 79% by weight of peptides having a molecular weight of greater than about 20 kDa, and
c) the composition comprises
   i. less than about 2 g calcium per 100 g total protein, and/or
   ii. less than about 1.4 g calcium per 100 g of the dry matter in the composition.

In one aspect the invention provides a milk protein composition comprising a milk protein concentrate, or a milk protein isolate, or a combination thereof, wherein
a) the composition comprises at least about 40% by weight total protein relative to the dry matter in the composition,
b) the total milk protein comprises
   from about 20 to about 79% by weight of peptides having a molecular weight of greater than about 20 kDa,
   from about 15% to about 55% by weight of peptides having a molecular weight of from about 5 to about 20 kDa,
   from about 2% to about 20% by weight of peptides having a molecular weight of from about 1 to about 5 kDa, and
   from about 2% to about 20% by weight of peptides having a molecular weight of less than about 1 kDa, and
c) the composition comprises
   i. less than about 2 g calcium per 100 g total protein, and/or
   ii. less than about 1.4 g calcium per 100 g of the dry matter in the composition.

In one aspect, the invention provides a method for preparing a milk protein composition, the method comprising
a) providing an aqueous composition comprising milk protein, the aqueous composition comprising from about 0.5 to about 20% by weight total protein,
b) subjecting the aqueous composition to the action of one or more proteolytic enzymes, and
c) inactivating the one or more proteolytic enzymes to produce the milk protein composition,
   wherein
1. the milk protein composition comprises at least about 40% by weight total protein relative to the dry matter in the composition,
2. the milk protein comprises casein,
3. the total milk protein comprises less than about 79% by weight of peptides having a molecular weight of greater than about 20 kDa, and
4. the composition comprises
   i. less than about 2 g calcium per 100 g total protein, and/or
   ii. less than about 1.4 g calcium per 100 g of the dry matter in the composition.

In one aspect, the invention provides a method for preparing a milk protein composition, the method comprising
a) providing an aqueous composition comprising a milk protein concentrate, or a milk protein isolate, or a combination thereof, the aqueous composition comprising from about 0.5 to about 20% by weight total protein,
b) subjecting the aqueous composition to the action of one or more proteolytic enzymes, and
c) inactivating the one or more proteolytic enzymes to produce the milk protein composition,
   wherein
1. the milk protein composition comprises at least about 40% by weight total protein relative to the dry matter in the composition,
2. the total milk protein comprises less than about 79% by weight of peptides having a molecular weight of greater than about 20 kDa, and
3. the composition comprises
   i. less than about 2 g calcium per 100 g total protein, and/or
   ii. less than about 1.4 g calcium per 100 g of the dry matter in the composition.

In one aspect the invention relates to a milk protein composition prepared by the method of the invention.

In one aspect the invention relates to a protein-containing food product comprising the milk protein composition of the invention.

In one aspect the invention relates to use of the milk protein composition of the invention in the preparation of a protein-containing food product.

In one aspect the invention relates to a protein-containing food product comprising the milk protein composition of the invention or a milk protein composition prepared by the method of the invention, wherein the food product is an acidified product or a fermented product.

In one aspect the invention relates to a protein-containing food product comprising the milk protein composition of the invention or a milk protein composition prepared by the method of the invention, wherein the food product is a yoghurt.

In one aspect, the invention provides a method for preparing a protein-containing food product, the method comprising
a) providing an aqueous composition comprising a milk protein composition of the invention or a milk protein composition prepared by a method of the invention, and
b) mixing with one or more additional ingredients to produce the protein-containing food product.

In one aspect the invention relates to a method of preparing an acidified protein-containing food product comprising
a) providing an aqueous composition comprising a milk protein composition of the invention or a milk protein composition prepared by a method of the invention,
b) acidifying the aqueous composition to produce an acidified protein-containing food product.

In one aspect the invention relates to a method of preparing a fermented protein-containing food product comprising
a) providing an aqueous composition comprising
   i. a milk protein composition of the invention or a milk protein composition prepared by a method of the invention, and
   ii. one or more cultures, and
b) incubating the aqueous composition for a time sufficient to produce the fermented protein-containing food product.

In one aspect, the invention provides a method for preparing a bar, the method comprising
a) providing a bar composition comprising
   i. a milk protein composition of the invention or a milk protein composition prepared by a method of the invention, and
   ii. one or more additional ingredients, and
b) forming the bar composition into a bar.

In one aspect, the invention provides a method for preparing a cheese, preferably a processed cheese, the method comprising
a) providing a cheese composition comprising
   i. a milk protein composition of the invention or a milk protein composition prepared by a method of the invention, and
   ii. one or more additional ingredients, and
b) heating the cheese composition at a temperature of at least about 70° C. to produce the cheese.

In one aspect, the invention provides a method for preparing a protein-containing food product, the method comprising
a) providing a milk protein composition comprising
   i. at least about 40% by weight total protein relative to the dry matter in the composition,
   ii. less than about 2 g calcium per 100 g total protein, and/or less than about 1.4 g calcium per 100 g of the dry matter in the composition;
b) mixing the milk protein composition with one or more additional ingredients to produce an aqueous intermediate composition comprising from about 0.5 to about 20% by weight total protein,
c) subjecting the aqueous intermediate composition to the action of one or more proteolytic enzymes, and
d) inactivating the one or more proteolytic enzymes to produce the food product.

In one aspect the invention provides a method for preparing an acidified protein-containing food product, the method comprising
a) providing a milk protein composition comprising
   i. at least about 40% by weight total protein relative to the dry matter in the composition,
   ii. less than about 2 g calcium per 100 g total protein, and/or less than about 1.4 g calcium per 100 g of the dry matter in the composition;
b) mixing the milk protein composition with one or more additional ingredients to produce an aqueous intermediate composition comprising from about 0.5 to about 20% by weight total protein,
c) subjecting the aqueous intermediate composition to the action of one or more proteolytic enzymes, and optionally inactivating the one or more proteolytic enzymes, and
d) acidifying the aqueous intermediate composition, to produce an acidified protein-containing food product,
   wherein steps c) and d) are performed in order or in reverse order.

In one aspect the invention provides a method for preparing a fermented protein-containing food product, the method comprising
a) providing a milk protein composition comprising
   i. at least about 40% by weight total protein relative to the dry matter in the composition,
   ii. less than about 2 g calcium per 100 g total protein, and/or less than about 1.4 g calcium per 100 g of the dry matter in the composition;
b) mixing the milk protein composition with one or more additional ingredients to produce an aqueous intermediate composition comprising from about 0.5 to about 20% by weight total protein,
c) subjecting the aqueous intermediate composition to the action of one or more proteolytic enzymes, and optionally inactivating the one or more proteolytic enzymes, and
d) adding one of more cultures to the aqueous intermediate composition and incubating for a time sufficient
to produce the fermented protein-containing food product,
wherein steps c) and d) are performed in order or in reverse order.

In one aspect, the invention provides a method for preparing a protein-containing food product, the method comprising
a) providing a milk protein composition comprising a milk protein concentrate, or a milk protein isolate, or a combination thereof, the milk protein composition comprising
   i. at least about 40% total protein by weight relative to the dry matter in the composition,
   ii. less than about 2 g calcium per 100 g total protein, and/or less than about 1.4 g calcium per 100 g of the dry matter in the composition;
b) mixing the milk protein composition with one or more additional ingredients to produce an aqueous intermediate composition comprising from about 0.5 to about 20% by weight total protein,
c) subjecting the aqueous intermediate composition to the action of one or more proteolytic enzymes, and
d) optionally inactivating the one or more proteolytic enzymes to produce the protein-containing food product.

In one aspect the invention provides a method for preparing an acidified protein-containing food product, the method comprising
a) providing a milk protein composition comprising a milk protein concentrate, or a milk protein isolate, or a combination thereof, the milk protein composition comprising
   i. at least about 40% total protein by weight relative to the dry matter in the composition,
   ii. less than about 2 g calcium per 100 g total protein, and/or less than about 1.4 g calcium per 100 g of the dry matter in the composition;
b) mixing the milk protein composition with one or more additional ingredients to produce an aqueous intermediate composition comprising from about 0.5 to about 20% by weight total protein,
c) subjecting the aqueous intermediate composition to the action of one or more proteolytic enzymes, and optionally inactivating the one or more proteolytic enzymes, and
d) acidifying the aqueous intermediate composition
to produce the acidified protein-containing food product,
wherein steps c) and d) are performed in order or in reverse order.

In one aspect the invention provides a method for preparing a fermented protein-containing food product, the method comprising
a) providing a milk protein composition comprising a milk protein concentrate, or a milk protein isolate, or a combination thereof, the milk protein composition comprising
   i. at least about 40% total protein by weight relative to the dry matter in the composition,
   ii. less than about 2 g calcium per 100 g total protein, and/or less than about 1.4 g calcium per 100 g of the dry matter in the composition;
b) mixing the milk protein composition with one or more additional ingredients to produce an aqueous intermediate composition comprising from about 0.5 to about 20% by weight total protein,
c) subjecting the aqueous intermediate composition to the action of one or more proteolytic enzymes, and optionally inactivating the one or more proteolytic enzymes, and
d) adding one of more cultures to the aqueous intermediate composition and incubating for a sufficient time,
to produce the fermented protein-containing food product,
wherein steps c) and d) are performed in order or in reverse order.

The following embodiments may relate to any or all of the above aspects.

In various embodiments the milk protein composition is a dried composition, preferably a powder.

In various embodiments, the milk protein or milk protein composition may comprise, or be provided by, a milk protein concentrate (MPC), a milk protein isolate (MPI), a caseinate, casein, a casein co-precipitate, a retentate obtained by ultrafiltration or microfiltration of milk, or any combination of any two or more thereof. In various embodiments, the milk protein or milk protein composition may comprise a milk protein concentrate (MPC), a milk protein isolate (MPI), or a combination thereof. In various embodiments, the milk protein or milk protein composition may comprise a milk protein concentrate (MPC) or a milk protein isolate (MPI). In various embodiments the milk protein may consist of a milk protein concentrate, or a milk protein isolate, or a combination thereof.

In various embodiments the retentate obtained by ultrafiltration or microfiltration of milk may comprise a micellar casein concentrate.

In various embodiments the total milk protein in the composition may comprise at least about 5, 10, 20, 30, 40, 50, 55, 60, 65, 70, 75, 80, 85, 90, 95 or 99% by weight casein, or the total milk protein in the composition may comprise 100% by weight casein. Various ranges may be selected from between any two of these values, for example, the total milk protein may comprise from about 5 to about 100, about 10 to about 100%, about 40 to about 100, about 50 to about 100, about 60 to about 100, about 70 to about 100, about 75 to about 100, about 80 to about 100%, about 5 to about 99, about 10 to about 99, about 40 to about 99, about 50 to about 99, about 60 to about 99, about 70 to about 99, about 75 to about 99, or about 80 to about 99% by weight casein.

In various embodiments the milk protein may comprise casein and whey protein.

In various embodiments the milk protein composition may further comprise a whey protein concentrate, or a whey protein isolate, or a combination thereof.

In various embodiments, the total milk protein may comprise less than about 79%, 78%, 77%, 76%, 75%, 70%, 65%, 60%, 55%, 50%, 45%, or 40% by weight of peptides having a molecular weight greater than about 20 kDa.

In various embodiments, the total milk protein may comprise from about 20 to about 79% by weight of peptides having a molecular weight greater than about 20 kDa.

In various embodiments, the total milk protein may comprise from about 15% to about 55% by weight of peptides having a molecular weight of from about 5 to about 20 kDa.

In various embodiments, the total milk protein may comprise less than about 30% by weight of peptides having a molecular weight of less than about 5 kDa.

In various embodiments, the total milk protein may comprise from about 5% to about 30% by weight of peptides having a molecular weight of less than about 5 kDa.

In various embodiments, the total milk protein may comprise less than about 20% by weight of peptides having a molecular weight of from about 1 to about 5 kDa.

In various embodiments, the total milk protein may comprise from about 2% to about 20% by weight of peptides having a molecular weight of from about 1 to about 5 kDa.

In various embodiments, the total milk protein may comprise less than about 20% by weight of peptides having a molecular weight of less than about 1 kDa.

In various embodiments, the total milk protein may comprise from about 2% to about 20% by weight of peptides having a molecular weight of less than about 1 kDa.

In various embodiments, the total milk protein may comprise
a) from about 20% to about 79% of peptides having a molecular weight of greater than about 20 kDa,
b) from about 15% to about 54% by weight of peptides having a molecular weight of from about 5 to about 20 kDa,
c) from about 2% to about 20% by weight of peptides having a molecular weight of from about 1 to about 5 kDa,
d) from about 2% to about 20% by weight of peptides having a molecular weight of less than about 1 kDa, or
e) any combination of any two or more of a) to d).

In various embodiments, the total milk protein may comprise
a) from about 20% to about 79% of peptides having a molecular weight of greater than about 20 kDa,
b) from about 15% to about 54% by weight of peptides having a molecular weight of from about 5 to about 20 kDa,
c) from about 2% to about 17% by weight of peptides having a molecular weight of from about 1 to about 5 kDa,
d) from about 2% to about 20% by weight of peptides having a molecular weight of less than about 1 kDa, or
e) any combination of any two or more of a) to d).

In various embodiments, the total milk protein may comprise
a) from about 35% to about 65% of peptides having a molecular weight of greater than about 20 kDa,
b) from about 25% to about 50% by weight of peptides having a molecular weight of from about 5 to about 20 kDa,
c) from about 4% to about 12% by weight of peptides having a molecular weight of from about 1 to about 5 kDa,
d) from about 2% to about 6% by weight of peptides having a molecular weight of less than about 1 kDa, or
e) any combination of any two or more of a) to d).

In various embodiments the milk protein may be at least partially hydrolysed. In various embodiments, the total milk protein may have a degree of hydrolysis of less than about 10%, about 9%, about 8%, about 7%, about 6%, about 5%, about 4%, about 3%, about 2%, about 1%, about 0.9%, about 0.8%, about 0.75%, about 0.7%, about 0.65%, about 0.5%, about 0.25%, about 2%, about 0.15% or less than about 0.1%.

In various embodiments the milk protein composition may comprise from about 50% to about 90% total protein by weight relative to the dry matter in the composition.

In various embodiments, the protein-containing food product may be a liquid nutritional composition, a beverage, ice cream, an acidified product, a fermented product, buttermilk, cheese, processed cheese, cheese analogues, quark, a pudding, a frozen dessert, coffee whitener, a gel, a bar, or a baked good.

In various embodiments the fermented product may be a yoghurt, a milk, a kefir, a skyr, a petit suisse, an ambient yoghurt, a fermented milk drink, a smoothie, or a sour cream. In various embodiments the yoghurt is a drinking yoghurt, a set yoghurt, a Greek-style yoghurt, or a stirred yoghurt.

In various embodiments, the acidified product may be an acid milk drink, a yoghurt, a cheese, a processed cheese, a cheese analogue, or a buttermilk.

In various embodiments the beverage may be a dairy beverage, an acidified beverage, a juice, a smoothie, or sports beverage. In various embodiments the dairy beverage may be a liquid nutritional composition, a low lactose milk, a flavoured milk or a fortified milk.

In various embodiments the food product may comprise a dairy base. In various embodiments the dairy base may comprise one or more of skim milk, skim milk powder, whey protein concentrate, whey protein isolate, whole milk powder, whole milk, lactose, standard milk protein concentrates, caseinates, cream, anhydrous milk fat, and fat filled milk powder.

In various embodiments the food product may comprise one or more lipids, carbohydrates, proteins, flavours, vitamins, minerals, milk products, water, food additives, colours, fruit preparations, or any combination of any two or more of these ingredients.

In various embodiments, the protein-containing food product exhibits a reduced firmness and/or viscosity compared to a control food product having the same ingredient composition, and casein and protein content as the food product of the invention except that the control food product does not comprise a milk protein composition of the invention.

In various embodiments the food product is a solid or set gel that has a reduced firmness compared to a control solid or set gel of from about 40% to about 80%. In other embodiments the food product is a semi-solid or liquid food product that exhibits a reduced viscosity compared to a control semi-solid or liquid food product of about 40% to about 99%.

In various embodiments, the food product exhibits reduced in-mouth texture (for example, firmness or thickness) and/or exhibits a negligible or no increase in undesirable flavours (for example, bitter or savoury flavours) compared to a control food product having the same ingredient composition, and casein and protein content as the food product of the invention except that the control food product does not comprise a milk protein composition of the invention.

In various embodiments, the aqueous composition may comprise less than about 2.5 g calcium per 100 g casein.

In various embodiments the method for preparing a milk protein composition may comprise subjecting a milk protein composition to ion exchange chromatography, calcium chelation, and/or ultrafiltration under acidic conditions to produce the aqueous milk protein composition. In various embodiments the calcium in the composition is reduced by at least about 40% by weight or by about 40 to about 99% by weight.

In various embodiments the method for preparing a milk protein composition further comprises drying the milk protein composition to form a powdered (dry) milk protein composition.

In various embodiments the proteolytic enzyme may comprise one or more proteases. In various embodiments the protease is an endopeptidase.

In various embodiments the protease may be a metalloprotein endopeptidase or a serine endopeptidase. In various embodiments the metalloprotein endopeptidase may be a zinc endopeptidase.

In various embodiments the proteolytic enzyme may comprise chymotrypsin, trypsin, pepsin, papain, bacillolysin, pancreatin, bromelain, carboxypeptidase, or a combination of any two or more thereof.

In various embodiments the proteolytic enzyme may have optimal activity at a pH of from about pH 6 to about pH 11.

In various embodiments the proteolytic enzyme may be derived from Bacillussp., for example Bacillus amyloliquefaciens, Aspergillus sp., for example, Aspergillus oryzae, Fusarium sp.

In various embodiments the method may comprise subjecting the aqueous composition to the action of one or more proteolytic enzymes
a) at a temperature of from about 0 to about 85° C.,
b) for a period of from about 30 seconds to about 48 hours,
c) at a pH of from about pH 6 to about pH 8, or
d) any combination of any two or more of a) to c).

In various embodiments the method may comprise subjecting the aqueous composition to the action of one or more proteolytic enzymes at a pH of from about pH 4 to about pH 11, about pH 6 to about pH 11, about pH 6 to about pH 10, about pH 6 to about pH 9, or about pH 6 to about pH 8.

In various embodiments the method may comprise adding one or more food grade acids or acidogens. In various embodiments the food grade acids or acidogens may be selected from the group consisting of glucono-delta lactone (GDL), lactic acid, citric acid, malic acid, acetic acid, tartaric acid, fumaric acid, hydrochloric, phosphoric, sulphuric, and any combination of any two or more thereof.

In various embodiments, the cultures are bacterial cultures. In various embodiments the cultures are selected from the group consisting of Lactobacillus, Streptococcus, Leuconostoc, Lactococcus, Lacticaseibacillus, or Bifidobacterium, for example Lactobacillus delbrueckii subsp. bulgaricus, Streptococcus thermophilus, Lactobacillus acidophilus, or Lacticaseibacillus casei.

In various embodiments, the acidifying or incubating the aqueous intermediate composition inactivates the one or more proteolytic enzymes.

In various embodiments, the yoghurt may be a set yoghurt having
a) a firmness of from about 300 to about 8000 g·s,
b) a fracture force of from about 10 to about 500 g, or
c) both (a) and (b).

In various embodiments, the yoghurt is a stirred yoghurt having a viscosity of from about 1 to about 4000 mPa·s at 50 s⁻¹.

In various embodiments, the yoghurt is a drinking yoghurt having a pourable, homogeneous consistency.

Any of the embodiments or preferences described herein may relate to any of the aspects herein alone or in combination with any one or more embodiments or preferences described herein, unless stated or indicated otherwise.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9, and 10) and also any range of rational numbers within that range (for example, 2 to 8, 1.5 to 5.5, and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### BRIEF DESCRIPTION OF THE DRAWINGS

The invention will now be described by way of example only and with reference to the drawings in which:

FIG. 1 is a flow chart showing exemplary methods of manufacturing the milk protein composition of the invention.

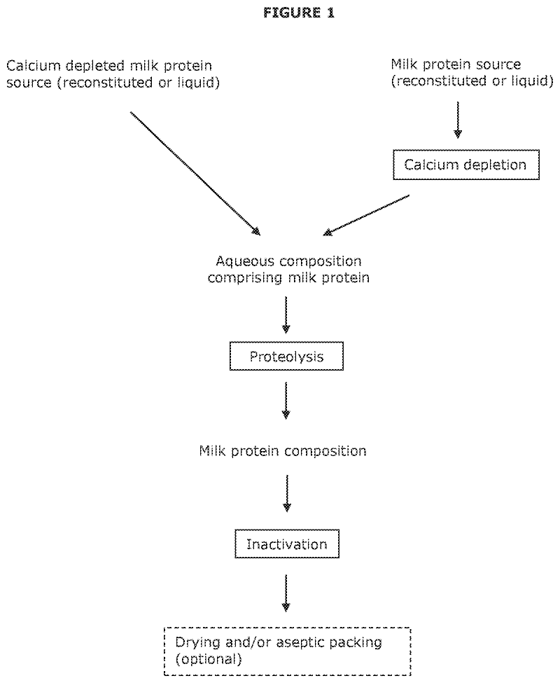

FIG. 2 is a flow chart showing exemplary methods of manufacturing the protein-containing food product of the invention.

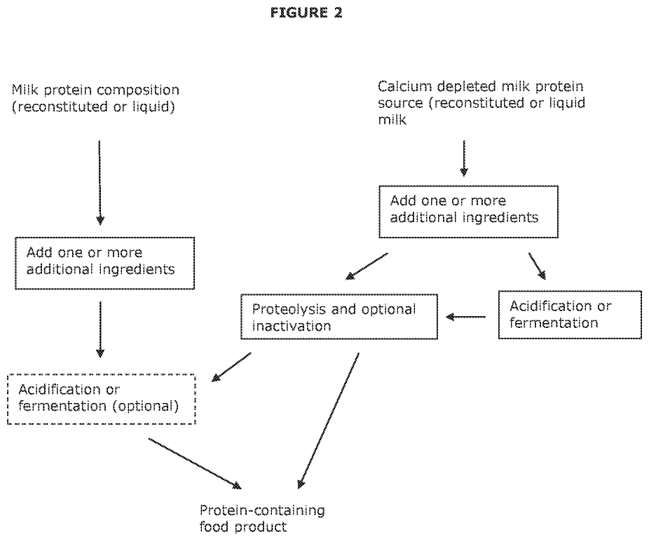

### DETAILED DESCRIPTION

The present invention relates to a milk protein composition that is low in calcium (calcium-depleted) and partially hydrolysed, and methods of making the milk protein composition. The invention also relates to food products comprising the milk protein composition, such as acidified and fermented food products, and methods of making said food products. The invention also relates to food products prepared using a calcium-depleted MPC where the partial hydrolysis of the milk protein is performed “in-line” during preparation of the food product.

Food products prepared from the milk protein compositions and/or using the methods described herein have reduced viscosity and/or firmness compared with known food products comprising alternative milk protein ingredients while retaining the desirable texture, flavour and other properties of the food product.

### 1. Definitions

The term “milk protein concentrate (MPC)” refers to a milk protein product in which greater than 40% weight of the non-fat solids are protein, or greater than 70%, greater than 80%, greater than 85% weight of the non-fat solids are protein and the weight ratio of casein to whey proteins is between about 95:10 and about 50:50, preferably between 90:10 and 80:20. A MPC with greater than 90% milk protein is sometimes referred to as milk protein isolate (MPI). Where reference is made to an MPC, it should be taken to include an MPI, where applicable in context. Milk protein concentrates can also include modified MPCs, such as a calcium-depleted MPCs or other counterion-modified MPCs. Such concentrates are known in the art. MPCs are frequently described with the % dry matter as milk protein being appended to ‘MPC’. For example, MPC70 is an MPC with 70% of the dry matter as milk protein.

The phrase ‘calcium depleted’ is used herein to refer to a composition, such as a milk protein concentrate (MPC), in which the concentration of calcium bound to casein has been reduced and is lower than the concentration of calcium bound to casein in the corresponding non-depleted composition. Such a composition may also be depleted in other divalent cations, and so have a lower concentration of divalent cations bound to casein, for example, magnesium, than the corresponding non-depleted composition. Similarly, reference to calcium in casein protein is a reference to bound calcium—that is, calcium bound by the casein protein.

The term ‘partially hydrolysed’ is used herein to refer to a milk protein that has been subjected to the action of one or more proteolytic enzymes.

The term ‘caseinate’ refers to a chemical compound of casein and a metal ion produced by acid precipitation of casein followed by resolubilisation with alkali comprising the metal ion. Hydroxide solutions comprising sodium, potassium, or ammonium may be used to produce sodium caseinate, potassium caseinate or ammonium caseinate. A description of caseinates and methods of producing caseinates suitable for use herein are described in Fox & McSweeney, 2003 and the Dairy Processing Handbook, 2003.

The term ‘food product’ as used herein means a composition for consumption by humans or animals, including foods and beverages. Consumption can be via eating or drinking. In various embodiments, the food products provided herein meet standards for food safety required by the U.S. Food and Drug Administration (FDA), the U.S. Department of Agriculture, the European Food Safety Authority, and/or other state or region food regulatory agencies. The term includes compositions that can be combined with or added to other ingredients to make compositions that can be ingested by humans or animals.

The term ‘liquid nutritional composition’ refers to an aqueous composition preferably consumed or administered by mouth. Alternatively, liquid nutritional compositions can be administered by other means, such as by tube feeding to the stomach of a patient, including naso-gastric feeding and gastric feeding. Liquid nutritional compositions include “medical foods”, “enteral nutrition”, “foods for special medical purposes”, liquid meal replacers, and supplements. The liquid nutritional compositions of the present invention provide significant amounts of protein, carbohydrate and usually fat; as well as optional vitamins and minerals. In exemplary embodiments the liquid nutritional compositions provide balanced meals.

The term ‘peptide’ as used herein refers to any compound consisting of two or more amino acids linked in a chain via a bond between the carboxyl group of one amino acid and amino group of an adjacent amino acid. The term includes peptides and proteins of any length or molecular weight, including peptides or proteins comprising two or more amino acids, for example, peptide comprising from 2 to 250, from 2 to 300 or from 2 to 400 amino acids, or peptides or proteins having a molecular weight of from less than 1 kDa to greater than 20 kDa. The term includes peptide or protein fragments that have been cleaved via hydrolysis from a longer peptide or protein as well as unhydrolyzed or “intact” peptides or proteins.

The term ‘milk protein’ as used herein refers to the value calculated from the percentage nitrogen in the sample using the following equation using the conversion factor for milk protein:

$$\% total milk protein = \% nitrogen \times 6.38$$

see Cunniff, P. ed. 1997. § 33.2.11 AOAC Official Method 991.20 Nitrogen (Total) in Milk. Official Methods of Analysis of AOAC International. 16th ed., 3rd Revision. Vol. II. AOAC International. Gaithersburg, MD. (Chapt. 33. 0 pg. 11).

As used herein, the term ‘total protein’ refers to all the protein, from any source or ingredient, present in a composition. ‘Total milk protein’ refers to all milk-derived protein (in particular, casein and whey proteins) in a composition.

The term ‘intact casein’ as used herein refers to casein protein in the milk protein composition that has undergone no substantial hydrolysis after being subjected to the action of a proteolytic enzyme.

The term ‘comprising’ as used herein means ‘consisting at least in part of’. When interpreting statements in this specification which include that term, the features, prefaced by that term in each statement, all need to be present but other features can also be present. Related terms such as ‘comprise’ and ‘comprised’ are to be interpreted in the same manner.

### 2. Milk Protein Composition

In one aspect the invention generally provides a milk protein composition comprising milk protein, wherein
a) the composition comprises at least about 40% by weight total protein relative to the dry matter in the composition,
b) the milk protein comprises casein,
c) the total milk protein comprises less than about 79% by weight of peptides having a molecular weight of greater than about 20 kDa, and
d) the composition comprises
   i. less than about 2 g calcium per 100 g total protein, and/or
   ii. less than about 1.4 g calcium per 100 g of the dry matter in the composition.

In various embodiments, the milk protein may comprise a milk protein concentrate (MPC), a milk protein isolate (MPI), a caseinate, casein, a casein co-precipitate, a retentate obtained by ultrafiltration or microfiltration of milk, or any combination of any two or more thereof. In various embodiments, the milk protein may comprise a milk protein concentrate (MPC), a milk protein isolate (MPI), or a combination thereof. In various embodiments, the milk protein may comprise a milk protein concentrate (MPC) or a milk protein isolate (MPI).

In one aspect the invention provides a milk protein composition comprising a milk protein concentrate, a milk protein isolate or a combination thereof, wherein
a) the composition comprises at least about 40% by weight total protein relative to the dry matter in the composition,
b) the total milk protein comprises less than about 79% by weight of peptides having a molecular weight of greater than about 20 kDa, and
c) the composition comprises
   i. less than about 2 g calcium per 100 g total protein, and/or
   ii. less than about 1.4 g calcium per 100 g of the dry matter in the composition.

In various embodiments, the composition comprises at least about 40%, about 45%, about 50%, about 60%, about 70%, about 80%, about 90% or at least about 95% by weight total protein relative to the dry matter in the composition, and various ranges may be selected from between any two of those ranges. In various embodiments the composition may comprise from about 40% to about 99%, about 40 to about 90% or about 40 to about 80% by weight total protein relative to the dry matter in the composition.

In various embodiments the milk protein or milk protein composition may comprise at least about 10, 20, 30, 40, 50, 55, 60, 65, 70, 75, 80, 85, 90, 95, 99 or 100% by weight casein relative to dry matter, and various ranges may be selected from between any two of these values, for example, from about 10 to about 100%, about 40 to about 100, about 50 to about 100, about 60 to about 100, about 70 to about 100, about 75 to about 100, or about 80 to about 100%, about 10 to about 90, about 40 to about 90, about 50 to about 90, about 60 to about 90, about 70 to about 90, about 75 to about 90, or about 80 to about 90%, by weight casein relative to dry matter.

In various embodiments the milk protein or milk protein composition may comprise whey protein. In various embodiments, the milk protein or milk protein composition may comprise from about 1 to about 50%, about 1 to about 40%, about 1 to about 30%, or about 1 to about 20% by weight whey protein relative to dry matter.

In various embodiments the whey protein may comprise or be provided by an ingredient comprising a whey protein concentrate, whey protein isolate or a combination thereof. Other suitable sources of whey protein known in the art may be used. For example, in some embodiments the whey protein may comprise or be provided by an ingredient comprising a whey liquid, such as cheese whey or acid whey.

The calcium-depleted milk protein (in particular, casein) present in the compositions described herein has been subjected to the action of a proteolytic enzyme to achieve partial hydrolysis. The partial hydrolysis of the calcium-depleted milk proteins achieves a molecular weight profile linked with the advantageous features described herein.

In various embodiments, the total milk protein may comprise less than about 79%, 78%, 77%, 76%, 75%, 70%, 65%, 60%, 55%, 50%, 45%, or 40% by weight of peptides having a molecular weight of greater than about 20 kDa.

In various embodiments, the total milk protein may comprise from about 20%, 25%, 30%, 35%, 40%, 45%, 50%, 55%, 60%, 65% or 70% to about 79% by weight of peptides having a molecular weight of greater than about 20 kDa, and various ranges may be selected from between any two or these values, for example, about 25% to about 79%, about 30% to about 79%, about 35% to about 79%, about 40% to about 79%, about 50% to about 79%, about 20% to about 75%, about 25% to about 75%, about 30% to about 75%, about 35% to about 75%, about 40% to about 75%, about 50% to about 75%, about 20% to about 70%, about 25% to about 70%, about 30% to about 70%, about 35% to about 70%, about 40% to about 70%, about 50% to about 70%, about 20% to about 65%, about 25% to about 65%, about 30% to about 65%, about 35% to about 65%, about 40% to about 65%, about 50% to about 65%, about 20% to about 60%, about 30% to about 60%, about 40% to about 60%, about 20% to about 55%, about 30% to about 5%, or about 40% to about 60% by weight of peptides having a molecular weight of greater than about 20 kDa.

In various embodiments, the total milk protein may comprise about 15, 20, 25, 30, 35, 40, 45, 50 or about 55% by weight of peptides having a molecular weight of from about 5 to about 20 kDa, and various ranges may be selected from between any two or these values, for example, about 15% to about 55%, about 15% to about 50%, about 15% to about 45%, about 15% to about 40%, about 15% to about 35%, 20% to about 50%, about 20% to about 45%, about 20% to about 40%, about 20% to about 35%, 25% to about 50%, about 25% to about 45%, about 25% to about 40%, about 25% to about 35%, 30% to about 50%, about 30% to about 45%, or about 30% to about 40% by weight of peptides having a molecular weight of from about 5 to about 20 kDa.

In various embodiments, the total milk protein may comprise less than about 30% peptides having a molecular weight of less than about 5 kDa, or less than about 28%, less than about 25%, less than about 24%, less than about 23%, less than about 22%, less than about 21%, or less than about 20% peptides having a molecular weight of less than about 5 kDa.

In various embodiments, the total milk protein may comprise from about 5%, 10%, 15%, 20%, 21%, 22%, 23%, 24% or 25% to about 30% peptides having a molecular weight of less than about 5 kDa, and various ranges may be selected from between any two or these values, for example, about 5% to about 25%, or about 10% to about 25%, or about 15% to about 25%, or about 20% to about 25%, about 5% to about 22%, about 5% to about 21%, or about 5% to about 20%, or about 10% to about 20%, or about 15% to about 20%, or about 5% to about 15%, or about 10% to about 15% peptides having a molecular weight of less than about 5 kDa.

In various embodiments, the total milk protein may comprise less than about 20% peptides having a molecular weight within the range of about 1 to about 5 kDa, or less than about 18%, less than about 16%, less than about 14%, or less than about 12% peptides having a molecular weight within the range of about 1 to about 5 kDa.

In various embodiments, the total milk protein may comprise from about 2%, 3%, 4%, 5%, 6%, 7%, 8%, 9% 10%, 11%, 12%, 13%, 14%, 15%, 16%, 17%, 18% to about 20% peptides having a molecular weight within the range of about 1 to 5 about kDa, and various ranges may be selected from between any two or these values, for example, from about 2% to about 18%, from about 2% to about 16%, from about 2% to about 15%, from about 2% to about 14%, from about 2% to about 12%, from about 2% to about 10%, from about 2% to about 9%, from about 3% to about 20% peptides, from about 3% to about 18%, from about 3% to about 16%, from about 3% to about 15%, from about 3% to about 14%, or from about 3% to about 12%, from about 3% to about 10%, from about 3% to about 9%, from about 4% to about 20% peptides, from about 4% to about 18%, from about 4% to about 16%, from about 4% to about 15%, from about 4% to about 14%, or from about 4% to about 12%, from about 4% to about 10%, from about 4% to about 9%, from about 5% to about 20% peptides, 5% to about 18%, from about 5% to about 16%, from about 5% to about 15%, from about 5% to about 14%, or from about 5% to about 12%, from about 5% to about 10%, or from about 5% to about 9% peptides having a molecular weight within the range of about 1 to 5 about kDa.

In various embodiments, the total milk protein may comprise less than about 20% peptides having a molecular weight of less than about 1 kDa, or less than about 15%, less than about 10% or less than about 9% peptides having a molecular weight of less than about 1 kDa.

In various embodiments, the total milk protein may comprise from about 2%, 3%, 4%, 5%, 6%, 7%, 8%, 9%, 10%, 15% to about 20% peptides having a molecular weight of less than about 1 kDa, and various ranges may be selected from between any two or these values, for example, about 2% to about 20%, about 2% to about 15%, about 2% to about 10%, about 2% to about 9%, about 2% to about 8%, about 2% to about 7%, about 2% to about 6%, about 2% to about 5%, about 3% to about 20%, about 3% to about 15%, about 3% to about 10%, about 3% to about 9%, about 3% to about 8%, about 3% to about 7%, about 3% to about 6%, about 3% to about 5%, about 5% to about 20%, about 5% to about 15%, or about 5% to about 10% peptides having a molecular weight of less than about 1 kDa.

In various embodiments, the total milk protein may have a peptide molecular weight profile corresponding to the following molecular weight distribution:
a) from about 20%, 25%, 30%, 35%, 40%, 45%, or 50% to about 79% of peptides having a molecular weight of greater than about 20 kDa,
b) from about 15, 20, 25, 30, 35, 40, 45, 50 or about 55% by weight of peptides having a molecular weight of from about 5 to about 20 kDa,
c) from about 2%, 3%, 4%, 5%, 10%, 12%, 14%, 16%, 18% to about 20% by weight of peptides having a molecular weight of from about 1 to about 5 kDa, and
d) from about 2%, 3%, 4%, 5%, 10%, 15% to about 20% by weight of peptides having a molecular weight of less than about 1 kDa.

In various embodiments, the total milk protein may have a peptide molecular weight profile corresponding to the following molecular weight distribution:
a) from about 20% to about 79% of peptides having a molecular weight of greater than about 20 kDa,
b) from about 15% to about 54% by weight of peptides having a molecular weight of from about 5 to about 20 kDa,
c) from about 2% to about 17% by weight of peptides having a molecular weight of from about 1 to about 5 kDa, and
d) from about 2% to about 20% by weight of peptides having a molecular weight of less than about 1 kDa.

In various embodiments, the total milk protein may comprise

a) less than about 79%, 78%, 77%, 76%, 75%, 70%, 65%, 60%, 55%, 50%, 45%, or 40% peptides having a molecular weight of greater than about 20 kDa, and b) from about 15 to about 55%, about 15% to about 50%, about 15% to about 45%, about 15% to about 40%, about 15% to about 35%, 20% to about 50%, about 20% to about 45%, about 20% to about 40%, about 20% to about 35%, 25% to about 50%, about 25% to about 45%, about 25% to about 40%, about 25% to about 35%, 30% to about 50%, about 30% to about 45%, or about 30% to about 40% peptides having a molecular weight within the range of about 5 to about 20 kDa.

In various embodiments, the total milk protein may comprise
a) less than about 79%, 78%, 77%, 76%, 75%, 70%, 65%, 60%, 55%, 50%, 45%, or 40% peptides having a molecular weight of greater than about 20 kDa, and
b) less than about 30%, less than about 28%, less than about 25%, or less than about 20% peptides having a molecular weight of less than about 5 kDa.

In various embodiments, the total milk protein may comprise
a) less than about 79%, 78%, 77%, 76%, 75%, 70%, 65%, 60%, 55%, 50%, 45%, or 40% peptides having a molecular weight of greater than about 20 kDa, and
b) less than about 20%, less than about 18%, less than about 16%, less than about 14%, or less than about 12% peptides having a molecular weight within the range of about 1 to about 5 kDa.

In various embodiments, the total milk protein may comprise
a) less than about 79%, 78%, 77%, 76%, 75%, 70%, 65%, 60%, 55%, 50%, 45%, or 40% peptides having a molecular weight of greater than about 20 kDa, and
b) less than about 20%, less than about 15%, or less than about 10% peptides having a molecular weight of less than about 1 kDa.

The molecular weight profile of the peptides present in the compositions described herein may be determined according to the following method. Proteins/peptides are separated using a size exclusion HPLC method with two TSK G2000 SW_{XL} columns in series (2×30 cm) and with a TSK SW_{XL} guard column, all maintained at 30° C. (TOSOH Corporation). Samples are dissolved in a mobile phase buffer consisting of 0.1 M potassium phosphate pH 6.0, 0.3 M potassium chloride and 6 M urea, to give a final protein concentration of 2-4 mg/mL. Reference standards (glutathione (reduced, 307 Da), insulin B chain (oxidised, 3,496 Da), myoglobin (16,952 Da), carbonic anhydrase (28,982 Da) and glyceraldehyde-3-phosphate dehydrogenase (35,688 Da) are run before and after each sample set. Samples are run with a flow rate of 0.45 ml/min using an injection volume of 50 uL of the 2-4 mg/mL sample solution, with a total run length of 70 minutes. Proteins and peptides are detected by monitoring the absorbance at 220 nm. The retention times of the standards are fitted to a quadratic curve and the resulting equation is used to calculate retention times corresponding to four molecular weight ranges i.e. >20 kDa, 5-20 kDa, 1-5 kDa and <1 kDa. For chromatograms of the hydrolysate samples, the area under the curve for each molecular weight range is then calculated and represented as a percent of the total protein/peptide material. Other suitable methods of determining molecular weight profile are well known in the art and will be apparent to a skilled worker.

In various embodiments the milk protein may be partially hydrolysed. In various embodiments, the milk protein may have a degree of hydrolysis of less than about 10%, about 9%, about 8%, about 7%, about 6%, about 5%, about 4%, about 3%, about 2%, about 1%, about 0.75%, about 0.5%, about 0.25%, about 0.2%, about 0.15% or less than about 0.1%, and suitable ranges may be selected from between any of these values, for example, from about 0.1 to about 10%, about 0.1 to about 5%, about 0.1 to about 3%.

Degree of hydrolysis is measured using the o-phthaldialdehyde OPA method originally described by Church et. al. 1983 (J Dairy Sci, 66 (6), 1219-1227), but with the modified reducing agent as reported by Frister et. al. 1988 (Fresenius' Zeitschrift für analytische Chemie, 330, 631-633).

Briefly, a sample is diluted in water to a level so that the absorbance is within the standard absorbance range. Glycine is diluted in water to achieve a standard curve from 0.25-1.00 μmol/mL glycine. 40 mg of OPA (dissolved in 1 mL methanol or ethanol) is added to 25 mL of 100 mM sodium tetraborate and 2.5 mL of 20% (wt/wt) SDS and made up to 50 mL with water. 100 mg of N,N-dimethyl-2-mercaptoethylammonium chloride was added in place of β-mercaptoethanol. Three millilitres of prepared MOPA reagent is added to 0.4 mL of sample and standards in cuvettes and the absorbency is read exactly 2 minutes using a spectrophotometer set to 340 nm. The degree of hydrolysis of the sample is calculated using the standard curve by calculating the number of amino groups and then calculating the percentage of the total theoretical number of peptide bonds per g of protein. Lysine side chains were accounted for in the calculation.

In various embodiments, the milk protein composition comprises less than about 2 g calcium per 100 g total protein, or less than about 1.9, 1.8, 1.6, 1.5, 1.4, 1.2, 1, 0.8, 0.75, 0.6, 0.5, 0.4, 0.3, 0.2 or 0.1 g calcium per 100 g total protein, and various ranges may be selected from between any two of these values, for example, from about 0.1 to about 2, about 0.5 to about 2, about 1 to about 2, about 0.1 to about 1.5, about 0.5 to about 1.5, or about 1 to about 1.5 g calcium per 100 g total protein.

In various embodiments, the milk protein composition may comprise less than about 1.4 g calcium per 100 g of the dry matter in the composition, or less than about 1.3, 1.2, 1.1, 1.0, 0.9, 0.8, 0.7, 0.6, 0.5, or 0.4 g calcium per 100 g of the dry matter in the composition.

Calcium content may be determined using inductively coupled plasma-optical emission spectrometry. A modified wet digestion procedure and ICP-OES determination was performed according to the method described in Methods for the Determination of Metals and Inorganic Chemicals in Environmental Samples. Method 200.2: Sample preparation procedure for spectrochemical determination of total recoverable elements. Environmental Systems Monitoring Laboratory, EPA, Cincinnati, Ohio, 1994.

In various embodiments, the milk protein composition comprises less than 65, 60, 55 or less than about 50 g intact casein per 100 g of the dry matter of the composition.

Intact caseins and hydrolysates can be identified and quantified using various methods including SDS-PAGE (Laemmli UK: Cleavage of structural proteins during the assembly of the head of bacteriophage T4. Nature. 1970, 227: 680-685. 10.1038/227680a0), and microfluidic SDS electrophoretic technology (SG Anema, 2009 The use of “lab-on-a-chip” microfluidic SDS electrophoresis technology for the separation and quantification of milk proteins. International Dairy Journal, Volume 19, Issue 4, April 2009, Pages 198-204), size exclusion HPLC and RP-HPLC (Maurmayr et al (2013). Detection and Quantification of αₛ₁-, αₛ₂-, β-, κ-casein, α-lactalbumin, β-lactoglobulin and lactoferrin in bovine milk by RPHPLC. Agriculturae Conspectus Scientificius 78, (3), 201-205.). SDS-PAGE and size exclusion HPLC techniques work on the principle of separating proteins and peptides by their mass while RP-HPLC separate proteins and peptides on their hydrophobicity/hydrophilicity. These methods can determine the decrease of intact casein in the hydrolysed material provided that the intact caseins in the starting material can be compared. The reduction in intact casein is shown by a reduction in intensity of the protein bands in the various electrophoretograms when an equal protein content is used, allowing the comparison of the hydrolysed and un-hydrolysed material. Provided that the initial casein content of the material is known, these techniques can be used to show the reduction of intact casein in the product.

When the casein content of the starting material is not known, HPLC-MS peptide profiling techniques can be used to measure hydrolysed casein and whey proteins. Absolute quantification is possible if marker casein and whey peptides are synthesised as standards, which is routinely done (McGrath (2016). Proteomic characterization of heat-induced hydrolysis of sodium caseinate. International Dairy Journal, 53, 51-59). This will allow the estimation of the amount of intact casein reduction and the casein and whey content provided in the starting material.

In various embodiments the milk portion composition is in an at least partially form, for example, the milk protein composition is a powder. In other embodiments the milk protein composition is in liquid form. In some embodiments the milk protein composition comprises a liquid that has been reconstituted from a powdered composition.

In various embodiments, the composition may comprise inactivated proteolytic enzyme.

### 3. Method for Preparing Milk Protein Composition

Disclosed herein are methods for producing calcium-depleted and partially hydrolysed milk protein compositions.

### Source Material

Any suitable source of milk protein may be used to prepare the milk protein compositions according to the methods disclosed herein.

In various embodiments, the milk protein may comprise a milk protein concentrate (MPC), a milk protein isolate (MPI), a caseinate, a casein, a casein co-precipitate, or any combination of any two or more thereof. In various embodiments, the milk protein may comprise a milk protein concentrate (MPC), a milk protein isolate (MPI), or a combination thereof. In various embodiments, the milk protein may comprise a milk protein concentrate (MPC) or a milk protein isolate (MPI).

Generally, MPCs are prepared by processes invoking ultrafiltration to prepare a stream enriched in casein and whey protein. In another embodiment, the milk protein concentrate may be prepared by blending a stream of skim milk with a stream of whey protein concentrate, treating either the skim milk stream or the combined stream by cation exchange and optionally concentrating or drying. Suitable MPCs for use herein may be prepared from a mixture of MPCs.

In various embodiments the caseinate may be a sodium caseinate, an ammonium caseinate, a potassium caseinate or a combination of any two or more thereof.

A casein co-precipitate comprises casein and whey, and may be obtained via the combination of heat and acidification to obtain a curd that is then processed and dried. Any casein co-precipitate prepared by any method known in the art is suitable, except for calcium co-precipitates.

In various embodiments the milk protein may comprise, or be provided by, a retentate obtained by ultrafiltration or microfiltration of milk.

In various embodiments the milk protein concentrate may be prepared by a method comprising subjecting fresh liquid milk to ultrafiltration and diafiltration to produce a retentate.

The milk protein may be provided in the form of a calcium depleted MPC. Calcium-depleted MPCs are MPCs in which the calcium content is lower than the corresponding non-depleted MPC. These products generally also have a lower content of other divalent cations, for example, magnesium, than corresponding non-depleted products. Preferably the calcium-depleted MPC is dried to a moisture content of less than 6%, or a water activity level that facilitates storage of the dry ingredient for several months without undue deterioration.

Preferred MPCs for use in the invention have calcium that is manipulated by a cation exchange method. The manufacture and application of these calcium-depleted MPCs have been previously disclosed in U.S. Pat. No. 7,157,108, published PCT application WO2008/026940 and US published patent application 2010/0021595. These documents are fully incorporated herein by reference. Other methods of preparing calcium depleted MPCs will be apparent to a skilled worker.

In other embodiments, the milk protein may be provided in the form of a non-calcium depleted milk source, such as an MPC or MPI. The milk protein may be subjected to a calcium depletion step before or after proteolysis to reduce the calcium content.

An aqueous composition comprising milk protein can be prepared from a powdered or liquid milk protein source, for example a powdered or liquid MPC, or a retentate. The aqueous composition comprising milk protein can be formed by mixing two or more source materials together to obtain the desired properties of the starting composition, such as protein and calcium levels.

In various embodiments, the aqueous composition comprises less than about 2.5 g calcium per 100 g casein, or less than about 2.4, 2.2, 2.0, 1.8, 1.6, 1.4, 1.2, 1.0, or 0.8 g per 100 g casein. In various embodiments, the aqueous composition comprises from about 0.8 to about 2.5 g per 100 g casein, or from about 1.0 to about 2.5, or from about 1.4 to about 2.5, or from about 2.0 to about 2.5, or from about 0.8 to about 2.0, or from about 1.0 to about 2.0, or from about 1.4 to about 2.0 g per 100 g casein.

In various embodiments the method may comprise subjecting a milk protein composition to ion exchange chromatography, calcium chelation, mixing with carbon dioxide with subsequent filtration, and/or ultrafiltration under acidic conditions to reduce the calcium in the composition by at least about 40, 50%, 60, 70, 80, 90, 95 or 99% by weight or to reduce the calcium in the composition by about 40 to about 99%, about 50 to about 99%, about 60 to about 99%, about 70 to about 95%, or about 40 to about 95%, or about 50 to about 95%, about 60 to about 95%, or about 40 to about 90%, or about 50 to about 90%, or about 60 to about 90%, or about 70 to about 90% by weight to produce the aqueous milk protein composition.

In various embodiments the ion exchange chromatography may comprise exchanging calcium in the milk protein composition for sodium, potassium or a combination thereof.

In various embodiments the aqueous composition may comprise at least about 2, 3, 4, 5, 6, 7, 8, 9, 10, 12, 14, 15, 16, 18, or at least about 20% by weight total protein relative to the dry matter in the composition, and various ranges may be selected from between any two or these values, for example, from about 2 to about 20, 4 to about 20, 5 to about 20, 8 to about 20, 2 to about 18, 4 to about 18, 5 to about 18, or about 8 to about 20% by weight total protein.

The milk protein composition may be used directly in the manufacture of a protein-containing food product. Alternatively, the liquid milk protein composition may be packaged aseptically, or dried to a powder and packaged.

### Proteolysis

In various embodiments the method comprises subjecting the aqueous composition to the action of one or more proteolytic enzymes to at least partially hydrolyse the milk protein in the composition. As used herein, unless otherwise defined, “subjecting to the action of one or more proteolytic enzymes” or similar means that at least a portion of the peptides in the milk protein undergo hydrolysis resulting in at least partial hydrolysis of the milk protein in the composition. To achieve at least partial hydrolysis, conditions must be optimised for the proteolytic enzyme(s), for example, the temperature, pH and duration of treatment must be adjusted to achieve proteolytic activity of the enzyme(s).

Any proteolytic enzyme that achieves at least partial hydrolysis of at least a portion of the milk protein may be used.

In various embodiments the proteolytic enzyme may comprise one or more proteases. In various embodiments, the one or more proteases belong to the Enzyme Commission (EC) classes 3.4.21 (serine proteases), 3.4.24 (metalloendopeptidases), or 3.4.17 (carboxypeptidases). In various embodiments, the one or more protease is a subtilisin, a serine protease, an acid protease, or a neutral protease. Examples of suitable proteolytic enzymes are described in WO2016164096A1. In various embodiments the protease is an endopeptidase.

In various embodiments, the one or more proteases may belong to one or more of the Enzyme Commission (EC) classes 3.4.21 (serine endopeptidases), 3.4.22 (cysteine endopeptidases), 3.4.24 (metalloendopeptidases), and 3.4.17 (metallocarboxypeptidases). In various embodiments, the one or more proteases may be a subtilisin, a serine protease, an acid protease, an alkaline protease, or a neutral protease.

In various embodiments, the one or more proteolytic enzymes may belong to one or more of the EC classes 3.4.17, 3.4.21, 3.4.22, 3.4.23.1, 3.4.23.2, 3.4.23.3, 3.4.23.5, 3.4.23.12, 3.4.23.15, 3.4.23.16, 3.4.23.17, 3.4.23.19, 3.4.23.20, 3.4.23.21, 3.4.23.22, 3.4.23.23, 3.4.23.24, 3.4.23.25, 3.4.23.26, 3.4.23.28, 3.4.23.29, 3.4.23.30, 3.4.23.31, 3.4.23.32, 3.4.23.34, 3.4.23.35, 3.4.23.36, 3.4.23.38, 3.4.23.39, 3.4.23.40, 3.4.23.41, 3.4.23.42, 3.4.23.43, 3.4.23.44, 3.4.23.45, 3.4.23.46, 3.4.23.47, 3.4.23.48, 3.4.23.49, 3.4.23.50, 3.4.23.51, 3.4.23.52, or 3.4.24. In various embodiments, the one or more proteolytic enzymes belong to the EC classes 3.4.21, 3.4.22, 3.4.23.1, 3.4.23.2, 3.4.23.3, 3.4.23.5, 3.4.23.12, 3.4.23.15, 3.4.23.16, 3.4.23.17, 3.4.23.19, 3.4.23.20, 3.4.23.21, 3.4.23.22, 3.4.23.23, 3.4.23.24, 3.4.23.25, 3.4.23.26, 3.4.23.28, 3.4.23.29, 3.4.23.30, 3.4.23.31, 3.4.23.32, 3.4.23.34, 3.4.23.35, 3.4.23.36, 3.4.23.38, 3.4.23.39, 3.4.23.40, 3.4.23.41, 3.4.23.42, 3.4.23.43, 3.4.23.44, 3.4.23.45, 3.4.23.46, 3.4.23.47, 3.4.23.48, 3.4.23.49, 3.4.23.50, 3.4.23.51, 3.4.23.52, or 3.4.24.

In various embodiments the proteolytic enzyme may comprise one or more proteases. In various embodiments the protease is an endopeptidase.

In various embodiments the protease may be a metalloprotein endopeptidase or a serine endopeptidase. In various embodiments the metalloprotein endopeptidase may be a zinc endopeptidase.

In various embodiments the proteolytic enzyme may comprise chymotrypsin, trypsin, pepsin, papain, bacillolysin, pancreatin, bromelain, carboxypeptidase, or a combination of any two or more thereof.

In various embodiments, the proteolytic enzyme is not an aspartic endopeptidase. In various embodiments, the proteolytic enzyme does not belong to the EC class 3.4.23.18.

In various embodiments the proteolytic enzyme may have optimal activity at a pH of from about pH 6 to about pH 11.

A proteolytic enzyme is considered to have optimal activity under a specific condition (e.g. a particular pH range or temperature) when the activity of the enzyme under that condition is at least 60%, at least 65%, or at least 70%, or at least 75%, or at least 80%, or at least 85%, or at least 90%, or at least 95% of the maximal rate of reaction catalysed by the enzyme under any condition.

In various embodiments the proteolytic enzyme may be derived from Bacillussp., Fusarium sp., or plant material.

In various embodiments the proteolytic enzyme may be derived from Bacillussp., for example Bacillus amyloliquefaciens, Bacillus subtilis, Bacillus stearothermophilus, Bacillus licheniformis, Aspergillus sp., for example, Aspergillus oryzae, or Fusarium sp. In various embodiments the proteolytic enzyme may be derived from Bacillus sp., for example Bacillus amyloliquefaciens, Aspergillus sp., for example, Aspergillus oryzae, Fusarium sp. In various embodiments the proteolytic enzyme may be derived from Bacillus sp., for example Bacillus amyloliquefaciens, Bacillus subtilis, Bacillus stearothermophilus, Bacillus licheniformis, or Fusarium sp.

In various embodiments, the proteolytic enzyme may be derived from plant material, for example fruit material or vegetable material. In various embodiments, the proteolytic enzyme may be derived from fruit material, for example pineapple or papaya. Examples of such enzymes are bromelain and papain.

In various embodiments, the method may comprise subjecting the aqueous composition to the action of one or more proteolytic enzymes at a temperature of from about 0 to about 85° C., about 0 to about 50° C., about 0 to about 40° C., about 0 to about 30° C., about 0 to about 20° C., about 1 to about 85° C., about 1 to about 50° C., about 1 to about 40° C., about 1 to about 30° C., or about 1 to about 20° C.

In various embodiments the method may comprise subjecting the aqueous composition to the action of one or more proteolytic enzymes for a period of from about 30 seconds to about 48 hours, 1 min to about 48 hours, 1 min to about 24 hours, 1 min to about 12 hours, 1 min to about 6 hours, 2 min to about 24 hours, 2 min to about 12 hours, 2 min to about 6 hours, 10 min to about 24 hours, 10 min to about 12 hours, 10 min to about 6 hours, 20 min to about 24 hours, 20 min to about 12 hours, or about 20 min to about 6 hours.

Preferably, a pH equivalent to the isoelectric point (pI) of casein (pH 4.6) is avoided before or after proteolysis. At the pI of casein, undesirable aggregation of casein in the milk protein may occur. Accordingly, in various embodiments the aqueous composition may have a pH greater than pH 4.7, 4.8, 4.9 or pH 5. In various embodiments the aqueous composition may have a pH of from about pH 4.7 to about pH 8, about pH 4.8 to about pH 8, about pH 5 to about pH 8, about pH 5.5 to pH 8 or about pH 6 to about pH 8.

In various embodiments the method may comprise subjecting the aqueous composition to the action of one or more proteolytic enzymes at a pH of from about pH 4.7 to about pH 8. In various embodiments the method may comprise subjecting the aqueous composition to the action of one or more proteolytic enzymes at a pH of from about pH 6 to about pH 8.

In various embodiments the method may comprise subjecting the aqueous composition to the action of one or more proteolytic enzymes at a temperature of from about 0 to about 85° C. for a period of from about 30 seconds to about 48 hours and at a pH of from about pH 4.7 to about pH 8. In various embodiments the method may comprise subjecting the aqueous composition to the action of one or more proteolytic enzymes at a temperature of from about 0 to about 85° C. for a period of from about 30 seconds to about 48 hours and at a pH of from about pH 6 to about pH 8.

In various embodiments the aqueous composition to which a proteolytic enzyme has been added is heated or incubated at a temperature and for a duration to achieve the desired degree of hydrolysis and/or molecular weight profile of the milk proteins. As will be appreciated by those in the art, the precise temperature and duration will vary according to the proteolytic enzyme used. Other conditions may be necessary to achieve the desired proteolysis, for example, the presence of certain cations and/or a specific pH to achieve optimal activity of the enzyme. A person skilled in the art can readily determine suitable conditions for a given proteolytic enzyme using manufacturer's information or basic trials without undue experimentation.

Suitable methods of inactivating the one or more proteolytic enzymes will be apparent to a skilled worker. In various embodiments the method may comprise inactivating the one or more proteolytic enzymes by one or more of the following inactivation methods:
heating at a temperature of at least about 70° C. for at least about 15 seconds,
modifying the pH to below pH 4 or above pH 11,
modification of the solvent conditions (e.g. increasing ionic strength by adding salt),
using an enzyme inhibitor (e.g. EDTA),
evaporation and drying,
immobilisation on an inert support (e.g. Roehm Eupergit, carrageenan particles, chitosan particles or any other suitable material and then used in a stirred tank or fixed bed reactor or on a membrane or on a hollow fibre reactor)
using an ultrafiltration membrane,
using a pulsed electric field, and/or
using ultrasonic processing.

In various embodiments, the method may comprise subjecting the composition to the action of one or more proteolytic enzymes to reduce intact casein in the composition of at least about 5%, about 10%, about 12%, about 15%, or at least about 18% by weight, and various ranges may be selected from between these values, for example from about 5% to about 18%, or from about 10% to about 18%, or from about 12% to about 18% or from about 15% to about 18%, or from about 5% to about 15%, or from about 10% to about 15%, or from about 12% to about 15%, or from about 5% to about 12%, or from about 10% to about 12%, or from about 5% to about 10%.

In various embodiments, the method may further comprise drying the milk protein composition. Any suitable methods in the art may be used, including concentration in an evaporator and/or a dryer. In various embodiments the milk protein composition may be dried to form a powder.

### 4. Protein-Containing Food Product

In another aspect the invention relates to a protein-containing food product comprising the composition of the invention.

In a further aspect the invention relates to use of the composition of the invention in the preparation of a protein-containing food product.

In various embodiments, the protein-containing food product may be a liquid nutritional composition, a beverage, ice cream, an acidified product, a fermented product, buttermilk, cheese, processed cheese, cheese analogues, quark, a pudding, a frozen dessert, coffee whitener, a gel, a bar, or a baked good.

In various embodiments the fermented product may be a yoghurt, a milk, a kefir, a skyr, a petit suisse, an ambient yoghurt, a fermented milk drink, a smoothie, or a sour cream. In various embodiments the yoghurt is a drinking yoghurt, a set yoghurt, a Greek-style yoghurt, or a stirred yoghurt.

In various embodiments the fermented product may be a yoghurt, a milk, a kefir, a skyr, a petit suisse, an ambient yoghurt, a fermented milk drink, a smoothie, fromage frais, mascarpone, crème fraiche or a sour cream. In various embodiments the yoghurt may be a drinking yoghurt, a set yoghurt, a Greek-style yoghurt, a strained yoghurt or a stirred yoghurt.

In various embodiments, the acidified product may be an acid milk drink, yoghurt, cheese, processed cheese, cheese analogue, or buttermilk.

In various embodiments the beverage may be a dairy beverage, an acidified beverage, a juice, a smoothie, or sports beverage. In various embodiments the dairy beverage may be a liquid nutritional composition, a low lactose milk, a flavoured milk or a fortified milk.

In various embodiments the processed cheese may be a processed cheese spread, “slice-on-slice” processed cheese, processed cheese “lollipops”, individually wrapped processed cheese slices, processed cheese triangles, processed cream cheese, processed cheese sauce, or processed cheese blocks.

In various embodiments, the pH of the protein containing food product may be from about pH 3 to about pH 8.

In various embodiments, the pH of the protein containing food product may be adjusted using food-safe acidic or basic additives. In various embodiments, the pH of the protein containing food product may be adjusted to about pH 3 to about pH 8, for example to about pH 4 to about pH 7, or about pH 4 to about pH 6.8, or about pH 5 to about pH 7, or about pH 5 to about pH 6.8. In various embodiments, the pH of the protein containing food product may be adjusted to about pH 6.8.

pH may be measured by equilibrating samples to 25° C. and measuring using a pH probe (EC620132, Thermo Scientific) after calibrating using standards at pH 4, 7, and 10 (Pronalys, LabServ). pH may also be measured using a model PHM250 Ion Analyzer MeterLab (Radiometer, Copenhagen). Other methods of measuring pH will be apparent to a skilled worker.

The food products prepared using the milk protein composition and/or methods of the invention may exhibit reduced firmness and/or viscosity compared to a control food product having the same ingredient composition, casein, and protein content as the food product of the invention except that the control food product does not comprise a milk protein composition of the invention and/or a control food product that is not prepared by the method of the invention. In various embodiments the food product is a solid or set gel that has a reduced firmness compared to a control solid or set gel of from about 40% to about 80%. In other embodiments the food product is semi-solid or liquid food product that exhibits a reduced viscosity compared to a control semi-solid or liquid food product of about 40% to about 99%.

The food products prepared using the milk protein composition and/or methods of the invention may exhibit reduced in-mouth texture (for example, firmness or thickness) and/or exhibit a negligible to no increase in undesirable flavours (for example, bitter or savoury) compared to a control food product having the same ingredient composition, casein, and protein content as the food product of the invention except that the control food product does not comprise a milk protein composition of the invention.

In various embodiments, the protein containing food product may comprise a milk protein composition of the invention and at least one source of lipid. In various embodiments, the protein containing food product may comprise a milk protein composition of the invention and at least one source of carbohydrate.

In various embodiments, the protein containing food product may be prepared by a method comprising providing a milk protein composition of the invention, and mixing with at least one source of lipid and at least one source of carbohydrate.

In various embodiments, the protein containing food product may comprise a milk protein composition of the invention, at least one source of lipid, and at least one source of carbohydrate.

In various embodiments, the protein-containing food product may comprise at least about 1%, 2%, 3%, 4%, 5%, 6%, 7%, 8%, 9%, 10%, 11%, 12%, 13%, 14%, 15%, 16%, 17%, 18%, 19%, 20%, 30%, 40%, or at least about 50% by weight total protein. In various embodiments, the protein-containing food product may comprise from about 1% to about 50% total protein by weight, and useful ranges may be selected from between any of these values (for example, from about 1% to about 40%, or from about 1% to about 30%, or from about 1% to about 20%, or about 1% to about 16%, 1% to about 15%, 1% to about 14%, or about 1% to about 12%, or about 1% to about 10%, or from about 2% to about 50%, or from about 2% to about 40%, or from about 2% to about 30%, or about 2% to about 20%, or about 2% to about 16%, 2% to about 15%, 2% to about 14%, or about 2% to about 12%, or about 2% to about 10%, from about 4% to about 50%, or from about 4% to about 40%, or from about 4% to about 30%, or about 4% to about 20%, or about 4% to about 16%, 4% to about 15%, 4% to about 14%, or about 4% to about 12%, or about 4% to about 10%, from about 5% to about 50%, or from about 5% to about 40%, or from about 5% to about 30%, or about 5% to about 20%, or about 5% to about 16%, 5% to about 15%, 5% to about 14%, or about 5% to about 12%, or about 5% to about 10%).

In various embodiments, the protein containing food product may comprise at least about 0.1% lipid by weight, such as about 0.1%, about 0.2%, or about 0.5%, or about 1%, or about 3%, or about 5%, or about 10% lipid by weight. In various embodiments, the protein containing food product may comprise from about 0.1% to 40% lipid by weight, and useful ranges may be selected from between any of these values (for example, from about 0.1% to about 40%, or about 0.5% to about 40%, or about 1% to about 40%, or about 3% to about 40%, or about 5% to about 40%, or about 10% to about 40%, or about 15% to about 40%, or about 20% to about 40%, or about 0.1% to about 35%, or about 0.5% to about 35%, or about 1% to about 35%, or about 3% to about 35%, or about 5% to about 35%, or about 10% to about 35%, or about 15% to about 35%, or about 20% to about 35%,or about 0.1% to about 30%, or about 0.5% to about 30%, or about 1% to about 30%, or about 3% to about 30%, or about 5% to about 30%, or about 10% to about 30%, or about 15% to about 30%, or about 20% to about 30%, or about 0.1% to about 20%, or about 0.5% to about 20%, or about 1% to about 20%, or about 3% to about 20%, or about 5% to about 20%, or about 10% to about 20%, or about 15% to about 20%).

In various embodiments, the protein containing food product may comprise at least about 0.1% carbohydrate by weight, such as about 0.1%, or about 0.5%, or about 1%, or about 3%, or about 5%, or about 10% carbohydrate by weight. In various embodiments, the protein containing food product may comprise from about 0.1% to 40% carbohydrate by weight, and useful ranges may be selected from between any of these values (for example, from about 0.1% to about 40%, or about 0.5% to about 40%, or about 1% to about 40%, or about 3% to about 40%, or about 5% to about 40%, or about 10% to about 40%, or about 15% to about 40%, or about 20% to about 40%, or about 0.1% to about 35%, or about 0.5% to about 35%, or about 1% to about 35%, or about 3% to about 35%, or about 5% to about 35%, or about 10% to about 35%, or about 15% to about 35%, or about 20% to about 35%,or about 0.1% to about 30%, or about 0.5% to about 30%, or about 1% to about 30%, or about 3% to about 30%, or about 5% to about 30%, or about 10% to about 30%, or about 15% to about 30%, or about 20% to about 30%, or about 0.1% to about 20%, or about 0.5% to about 20%, or about 1% to about 20%, or about 3% to about 20%, or about 5% to about 20%, or about 10% to about 20%, or about 15% to about 20%).

In various embodiments, the protein containing food product may comprise at least about 15 mg/100 g calcium.

In various embodiments, the protein containing food product may comprise at least about 40 mg/100 g calcium.

In various embodiments, the food product is an acidified or fermented food product that exhibits reduced firmness and/or viscosity compared to a control food product having the same ingredient composition, and the same casein and protein content as the food product of the invention except that the control food product does not comprise a milk protein composition of the invention. For a food product that is a solid/set gel, the fermented food product exhibits an about 40% to about 80% decrease in firmness. For a food product that is semi-solid or liquid, the fermented food product exhibits an about 40% to about 99% decrease in viscosity.

In various embodiments, the food product is an acidified or fermented food product that exhibits reduced in-mouth texture (for example, firmness or thickness) and/or exhibits negligible to no increase in undesirable flavours (for example bitter or savoury) compared to a control food product having the same ingredient composition, and the same casein and protein content as the food product of the invention except that the control food product does not comprise a milk protein composition of the invention.

For the avoidance of doubt, the control food product comprises the same ingredients in the same relative amounts and the same casein, total protein, lipid and/or carbohydrate content as the inventive food product to which it is to be compared.

### Additional Ingredients

In various embodiments, the one or more additional ingredients may be a lipid, a carbohydrate, a protein, a flavour, a vitamin, a mineral, a milk product, water, a food additive, a colour, a fruit preparation, or any combination of any two or more of these ingredients.

In various embodiments the lipid may be plant lipid or animal lipid, including dairy lipid. Plant oils are often exemplary because of their ease of formulation and lower saturated fatty acid content. Exemplary plant oils include canola (rapeseed) oil, corn oil, sunflower oil, olive, soybean oil, or hydrogenated vegetable oil.

In various embodiments, the dairy lipid may be cream, butter, ghee, anhydrous milk fat (AMF), buttermilk, a hydrolysate thereof, combinations of hydrolysed and/or non-hydrolysed compositions, a hard milk fat extract from one or more stages of milk fat fractionation (including hard (H), soft-hard (SH), and soft-soft-hard (SSH) extracts), a soft milk fat extract from one or more stages of milk fat fractionation (including soft (S), soft-soft (SS), and soft-soft-soft (SSS) extracts), a combination of hard milk fat extracts, a combination of soft milk fat extracts, a combination of hard milk fat extracts and soft milk fat extracts, or any combination of any two or more thereof. These compositions may be obtained from whole milk or colostrum, and any derivatives of whole milk or colostrum, including cream, cultured cream, and whey cream (milk lipid obtained from whey, including acid whey or cheese whey, preferably cheese whey). Cultured cream is cream from whole milk or colostrum that has been fermented with acid-producing microorganisms, preferably lactic acid bacteria.

In various embodiments, the plant oil may be coconut oil, corn oil, cottonseed oil, canola oil, rapeseed oil, olive oil, palm oil, peanut oil, ground nut oil, safflower oil, sesame oil, soybean oil, sunflower oil, hazelnut oil, almond oil, cashew oil, macadamia oil, pecan oil, pistachio oil, walnut oil, oils from melon and gourd seeds, pumpkin seed oil, apricot oil, argan oil, avocado oil, flax oil, flax seed oil, grape seed oil, hemp oil, linseed oil, rice bran oil, wheat germ oil, or any combination of any two or more thereof. In some embodiments the plant oil may be hydrogenated coconut oil.

In various embodiments, the carbohydrate may comprise monosaccharides, disaccharides, oligosaccharides and polysaccharides and mixtures thereof, including sugar, sucrose, and sucralose. A number of these are commercially available as starch, modified starch, maltodextrin (3-20 dextrose equivalents (DE)) or corn syrup for the longer chain carbohydrates (>20 DE). Non-digestible carbohydrates may also be included, for example, fructooligosaccharides, inulin, and galactooligosaccharides. In various embodiments the carbohydrate may comprise a polyol, for example, a polyol selected from the group comprising glycerol (glycerine), maltitol, erythritol, sorbitol and any combination of any two or more thereof.

In various embodiments, the protein may be a dairy protein or a non-dairy protein. In various embodiments, the protein may be milk, whey, casein, caseinate, egg, egg white, egg yolk, vegetable, plant, alfalfa, clover, pea, bean, kidney bean, soybean, lentil, lupin, cocoa, carob, nut, peanut, rye, cereal, whole wheat, rice, hemp, wheat gluten, fungal, or algal protein, a protein concentrate thereof, a protein isolate thereof, a hydrolysate thereof, or any combination of any two or more thereof.

In various embodiments, the protein may be a protein powder. The protein powder may be of any of the protein sources described. The protein powder may be non-agglomerated, agglomerated, roll-compacted, freeze dried, drum dried, spray dried or foam spray dried protein powder. In various embodiments the protein powder comprises a whey protein concentrate (WPC) or a whey protein isolate (WPI). In various embodiments the protein powder comprises whole milk powder, skim milk powder, or a milk protein concentrate (MPC).

In various embodiments the one or more additional ingredients may be flavours, including but not limited to sweeteners, natural flavours, nature identical flavours, artificial flavours, herbs, and spices.

In some embodiments the one or more additional ingredients may comprise nuts and/or seeds.

In various embodiments the one or more additional ingredients may be vitamins. Vitamins may include fat-soluble or water-soluble vitamins. Suitable vitamins include but are not limited to vitamin C, vitamin A, vitamin E, vitamin B12, vitamin K, riboflavin, niacin, vitamin D, vitamin B6, folic acid, pyridoxine, thiamine, pantothenic acid, and biotin. The form of the vitamin may include salts of the vitamin, derivatives of the vitamin, compounds having the same or similar activity of a vitamin, and metabolites of a vitamin.

In various embodiments the one or more additional ingredients may be minerals, including, but not limited to chloride, sodium, calcium, iron, chromium, copper, iodine, zinc, magnesium, phosphorus, potassium and chromium. Suitable forms of any of the foregoing minerals include soluble mineral salts, slightly soluble mineral salts, insoluble mineral salts, chelated minerals, mineral complexes, non-reactive minerals such as carbonyl minerals, and reduced minerals, and combinations thereof.

In various embodiments the food product may comprise at least about 10, 20, 25, 30, 40, 50, 60, 70, 75, 80, 90 or 100% of the recommended daily intake (RDI) of vitamins and minerals as set by European (FSMP) or USDRA regulations in, for example, a 100 mL, 250 mL, 500 mL or 1 litre portion.

In various embodiments, the one or more additional ingredients may be a dairy product. In some embodiments, the dairy product may be selected from powdered milk protein concentrate, skim milk powder, whole milk powder, whey protein concentrate, whey protein isolate, caseinates, milk fat, cream, rennet casein, cheese, or cream cheese. In various embodiments, the one or more additional ingredients may be other milk products such as powdered milk protein concentrate, skim milk powder, whole milk powder, whey protein concentrate, whey protein isolate, caseinates, milk fat, or cream.

In various embodiments the one or more additional ingredients may be a food additive, including but not limited to rennet, antifoams, stabilisers, emulsifiers, preservatives, fibre, probiotics, antioxidants, flavour enhancers, colours, acidity regulators, or emulsifying salts. In various embodiments the one or more additional ingredients may be a food additive, including but not limited to rennet, antifoams, stabilisers, emulsifiers, preservatives, fibre, probiotics, antioxidants, flavour enhancers, colours, acidity regulators. A useful preservative is potassium sorbate in acidified products.

In various embodiments the one or more additional ingredients may be stabilisers or emulsifiers. Useful emulsifiers include lecithins, mono and diglycerides, polyglycerol esters, milk phospholipids, citric acid esters (citrems), polysorbate 60, glyceryl monostearate, and datems. Useful stabilisers include carrageenan, gellan gum, pectin, guar gum, locust bean gum, carboxymethyl cellulose, alginates, agar, oat gum, tragacanth gum, acacia gum, xanthan gum, karaya gum, tara gum, starch, and modified starch and microcrystalline cellulose, gelatin, or combinations thereof. Useful stabilisers include carrageenan, gellan gum, pectin, guar gum, locust bean gum, carboxymethyl cellulose, alginates, agar, oat gum, tragacanth gum, acacia gum, xanthan gum, karaya gum, tara gum, starch, and modified starch and microcrystalline cellulose or combinations thereof. Those of skill in the art will recognise that many different gum forms, in addition to those listed above are suitable for use in the compositions disclosed herein.

In various embodiments, the one or more additional ingredients may be salts or acidity regulators, such as sodium chloride, potassium chloride, ethylenediaminetetraacetic (EDTA) salts, lactic acid, acetic acid, citric acid, potassium hydroxide, phosphate salts such as dipotassium phosphate and disodium phosphate, citrate salts such as disodium citrate, dipotassium citrate, or tripotassium citrate. In some embodiments the citrate salts may be selected from the group comprising disodium citrate, dipotassium citrate, tripotassium citrate and trisodium citrate. In some embodiments the phosphate salts may be selected from the group consisting of dipotassium phosphate, disodium phosphate, orthophosphates, diphosphates, and polyphosphates.

In various embodiments, the one or more additional ingredients may be a source of amino acids, amino acid precursors or amino acid metabolites or any combination of any two or more thereof, preferably free amino acids, amino acid precursors or amino acid metabolites.

Methods of mixing the one or more additional ingredients with the milk protein concentrate to produce a protein-containing food product will depend on the protein-containing food product to be formed. These methods will be known to a skilled worker.

### 5. Yoghurts

The milk protein composition of the invention is particularly useful in the manufacture of yoghurts.

In various embodiments the protein-containing food product is a yoghurt. In various embodiments the yoghurt is a set yoghurt or a stirred yoghurt. In various embodiments the stirred yoghurt is a drinking yoghurt.

In various embodiments the protein-containing food product is an ambient yoghurt. Ambient yoghurt are heat-treated after fermentation to provide a yoghurt that is shelf-stable (for example, no significant microbial growth) for a defined period of storage at ambient temperature.

In various embodiments, the pH of the yoghurt is less than about pH 4.7.

In various embodiments, the pH of the yoghurt is less than about pH 4.6.

In various embodiments, the yoghurt has titratable acidity (TA) from about 0.9 to about 2.0 (equivalent lactic acid %). In other embodiments the yoghurt has titratable acidity (TA) from about 0.6 to about 2.0(equivalent lactic acid %). TA is measured by bringing the food sample to 20-25° C. and mixing to ensure homogeneity. 10 g of sample is weighed into a glass beaker, mixed with 10 ml of distilled water and stirred continuously using a magnetic stirrer. A PH electrode is placed in the sample solution and the solution is titrated to pH 8.30 using 0.1 M sodium hydroxide. The volume (mL) of NaOH is recorded and the titratable acidity as an equivalent of lactic acid is calculated using the equation:

$$TA = ( Volume of NaOH ( mL ) \times 0.09 / ( mass of yoghurt ( g ) )$$

In various embodiments, the set yoghurt has a firmness of from about 300 to about 8000 g·s, or from about 500 to about 8000, or about 1000 to about 8000, or from about 2000 to about 8000, or from about 3000 to about 8000, or from about 4000, to about 8000, or from about 5000 to about 8000, or from about 500 to about 7000, or about 1000 to about 7000, or from about 2000 to about 7000, or from about 3000 to about 7000, or from about 4000, to about 7000, or from about 5000 to about 7000, or from about 500 to about 5000, or about 1000 to about 5000, or from about 2000 to about 5000, or from about 3000 to about 5000 g·s.

In various embodiments, the set yoghurt has a fracture force of from about 10 to about 500 g, or from about 20 to about 500, or from about 50 to about 500, or from about 100 to about 500, or from about 200 to about 500, or from about 300 to about 500, or from about 20 to about 400, or from about 50 to about 400, or from about 100 to about 400, or from about 200 to about 400, or from about 300 to about 400, or from about 20 to about 300, or from about 50 to about 300, or from about 100 to about 300, or from about 200 to about 300 g.

Fracture force and firmness may be evaluated using a TAHD Plus Texture Analyser from Stable Micro Systems. A 1.27 cm Perspex cylinder is used in a single compression test; the initial force to break the surface of the set yoghurt is recorded as the fracture force (g) and the area under the curve was recorded as the firmness (g·s).

In various embodiments, the stirred yoghurt has a viscosity of less than about 1, 2, 3, 4, 5, 6, 7, 8, 9, 10, 12, 15, 17, 18, 20, 25, 30, 40, 50, 100, 200, 250, 500, 750, 1000, 1250, 1500, 1750, 2000, 2500, 3000 or less than about 4000 mPa·s at 50 s⁻¹, and various ranges may be selected from between any of these values, for example, from about 1 to about 4000, about 1 to about 2000, about 1 to about 1000, about 1 to about 500, about 1 to about 200, about 1 to about 100, about 1 to about 50, about 1 to about 30, about 1 to about 20, 5 to about 4000, about 5 to about 2000, about 5 to about 1000, about 5 to about 500, about 5 to about 200, about 5 to about 100, about 5 to about 50, about 5 to about 30, about 5 to about 20, 10 to about 4000, about 10 to about 2000, about 10 to about 1000, about 10 to about 500, about 10 to about 200, about 10 to about 100, about 10 to about 50, about 10 to about 30, or about 10 to about 20 mPa·s at 50 s⁻¹.

Viscosity may be determined using a Haake VT500 or Viscotester IQ viscometer. Samples are refrigerated (4° C.) and the Haake water bath is set to 10° C. Samples are stirred gently prior to testing to achieve a homogeneous consistency. A cup and bob configuration is used, using a MV1 or SV DIN rotor depending on the thickness of the sample. The cup is filled with the yoghurt sample up to the line marking, making sure to avoid air bubbles. The rotor is screwed into the instrument and zeroed and the bob is placed in the cup and cup is secured in place. A shear rate sweep from 0 to 120 1/s is applied and the apparent viscosity is reported at 50 s⁻¹.

In various embodiments, the drinking yoghurt has a pourable, homogeneous consistency. In various embodiments, the drinking yoghurt has a viscosity of less than about 1, 2, 3, 4, 5, 7, 8, 10, 20, 30, 40, 50, 60, 70, 80, 90, 100, 125, 150, 200, 300, 400, 500, 600, 700 or less than about 800 mPa·s at 50 s⁻¹ and various ranges may be selected from between any of these values, for example, from about 0 to about 800, about 0 to about 500, about 0 to about 200, about 0 to about 100, about 0 to about 50, about 0 to about 30, about 2 to about 800, about 2 to about 500, about 2 to about 200, about 2 to about 100, about 2 to about 50, about 2 to about 30, about 5 to about 800, about 5 to about 500, about 5 to about 200, about 5 to about 100, about 5 to about 50, or about 5 to about 30 mPa·s at 50 s⁻¹.

Sensory attributes of set yoghurts may be assessed using the following sensory procedure. The set yoghurts are presented in clear sample cups labelled with randomised 3-digit blinding codes. The samples are stored at 4° C. and presented to the panel soon after removing from the chiller. Sensory evaluation is performed by a panel of 8 expert panellists familiar with a high degree of experience tasting yoghurts. The yoghurt samples are evaluated with participants describing the texture and flavour attributes and intensities. A consensus approach is used to collate the attributes that best described each sample.

Flavour may be assessed using a trained sensory panel. For example, samples are evaluated by trained sensory panellists (n=8-12) utilising a sensory lexicon created during an attribute generation session. One attribute generation session and one training and calibration session are held prior to two consensus profiling evaluation sessions. With consensus profiling, members of the trained sensory panel work together to agree on intensity ratings (on a 0-150 mm line scale) for each sensory attribute rather than providing independent ratings in duplicate or triplicate. All samples are evaluated in duplicate across two sessions, with one sample evaluated in duplicate within each session. All samples are evaluated at room temperature (approximately 18-20° C.) and tasted under white lights in clear sample cups labelled with random 3 digit codes. The samples are presented to the panellists in a randomised order. Other sensory panels or alternative methods of assessing flavour will be apparent to a skilled worker.

In various embodiments, the yoghurt has an acceptable bitterness. On a 150 point (mm) scale, the threshold for attributes are approximately 10-15 for typical consumers (depending on the person). The scores in the example of 4.5 and below indicates that it is likely that some panellists could not detect bitterness. Therefore assumption could be made that the level of bitterness detected by the formal panel would be acceptable by some consumers. A reference of 0.01% caffeine in filtered water was used as a threshold intensity, 0.03% as a weak intensity and 0.06% as a medium intensity.

Particle size distribution may be determined using a Malvern Mastersizer 2000. Deionized water (refractive index (RI)=1.33) is used to disperse the sample and the refractive index of milk fat (RI=1.46) is used for the dispersed phase. Drops of sample are added until obscuration values of 10-15% are obtained. Particle sizes are reported as the surface weighted mean diameter (D [3,2]) and volume weighted mean diameter (D [4,3]).

In various embodiments, the D[3,2] particle size distribution of the acid milk drink is less than about 15 μm, or about 14 μm, or about 13 μm, or about 12 μm, or about 11 μm, or about 10 μm.

Viscosity of acid milk drinks may be determined using a Brookfield DV2T viscometer. Samples are stirred gently prior to testing to achieve a homogeneous consistency. A constant speed of either 30 or 60 rpm is used with a spindle no. of S-61, S-62, S-63 or S-64, depending on the viscosity of the samples; testing is done at ambient temperature. The viscosity is taken 60 seconds after the beginning of the test or until a constant value was achieved. The viscosity is expressed in terms of millipascal-second (mPa·s).

### 6. Protein Bars

The milk protein compositions described herein are particularly useful in the manufacture of protein bars. The milk protein compositions of the invention may be useful in producing protein bar having a high protein content, while maintaining an acceptable fracture force, water activity, and flavour. A skilled worker will appreciate protein bars will have a suitable fracture force to ensure the correct texture of bar and a suitable water activity to limit xerophilic yeast and mould growth.

In various embodiments the protein-containing food product is a protein bar.

In various embodiments, the protein bar has a fracture force of from about 500 g to about 10,000 g, or from about 500 g to about 9,000 g, or from about 500 g to about 8,000 g, or from about 500 g to about 7,000 g, or from about 500 g to about 6,000 g, or from about 500 g to about 6,000 g, or from about 500 g to about 4,000 g, or from about 500 g to about 3,000 g, 1,000 g to about 10,000 g, or from about 1,000 g to about 9,000 g, or from about 1,000 g to about 8,000 g, or from about 1,000 g to about 7,000 g, or from about 1,000 g to about 6,000 g, or from about 1,000 g to about 6,000 g, or from about 1,000 g to about 4,000 g, or from about 1,000 g to about 3,000 g, 2,000 g to about 10,000 g, or from about 2,000 g to about 9,000 g, or from about 2,000 g to about 8,000 g, or from about 2,000 g to about 7,000 g, or from about 2,000 g to about 6,000 g, or from about 2,000 g to about 6,000 g, or from about 2,000 g to about 4,000 g, or from about 2,000 g to about 3,000 g.

The fracture force (g) of the bars may be evaluated using a TAHD Plus texture analyser from Stable Micro Systems, Godalming, England. The texture measurements were performed by penetration. Forces were measured over a set penetration depth of 12 mm. A 5 mm stainless steel cylindrical probe was pushed into the bar at a constant rate of 1 mm/s to a depth of 12 mm, and was then withdrawn at a rate of 10 mm/s. The force (g) versus time (s) for the movement of the probe was measured. Three compressions were made over the surface of each bar sample. Two bars were evaluated for each sample. The samples were removed from 20° C. storage and texture measurements were made at 20° C. in a temperature-controlled room.

In various embodiments, the protein bar has a water activity of less than about 0.65, or less than about 0.6, or less than about 0.55, or less than about 0.5.

The water activity may be measured by: Water activity analysis was performed using an Aqua Lab Dew Point Moisture Analyzer 4TE DUO (Meter, Pullam, WA, USA). Standard solutions are measured to check calibration followed by the direct measurement of the samples.

Sensory attributes of protein bars may be assessed using the following sensory procedure. The bars are presented in clear sample cups labelled with randomised 3-digit blinding codes. Sensory evaluation is performed by a panel of at least 7 expert panellists familiar with tasting bars. A warm-up sample compared to the control is initially tasted to calibrate the panel in terms of taste and texture attributes using a 0 to 7 point scale with 0 exhibiting no difference, and 7 having an extreme difference to the control. The protein samples are evaluated with participants describing the texture and flavour attributes and intensities compared to a control sample.

The colour of the bars may be measured using a ColorFlex EZ (HunterLab) with the Universal programme. A standard white and black tile was used for calibration. The colour is reported using the L*, a*, b* colour space.

In one aspect, the invention provides a method for preparing a bar, the method comprising
a) providing a bar composition comprising
   i. a milk protein composition of the invention or a milk protein composition prepared by a method of the invention, and
   ii. one or more additional ingredients, and
b) forming the bar composition into a bar.

In various embodiments, the method comprising heating and/or mixing the bar composition.

In various embodiments, the method comprises forming the bar composition into a bar by moulding the composition and/or extruding the composition. In various embodiments the bar composition is moulded or extruded then cut into bars.

### 7. Cheese

The milk protein compositions described herein are particularly useful in the manufacture of cheese, in particular, processed cheese. The milk protein compositions of the invention may be useful in producing processed cheese having a high protein content, while maintaining an acceptable firmness, yield stress, melt properties and flavour.

In various embodiments the protein-containing food product is processed cheese. In various embodiments the processed cheese may be a processed cheese spread, “slice-on-slice” processed cheese, processed cheese “lollipops”, individually wrapped processed cheese slices, processed cheese triangles, processed cream cheese, processed cheese sauce, or processed cheese blocks.

In various embodiments, when the processed cheese is a individually wrapped processed cheese slice or a “slice-on-slice” processed cheese, the processed cheese has a firmness of from about 6N to about 15N, or from about 6N to about 14N, or from about 6N to about 13N, or from about 6N to about 12N, or from about 7N to about 15N, or from about 7N to about 14N, or from about 7N to about 13N, or from about 7N to about 12N.

Firmness may be evaluated with a penetration test using a TAHD Plus Texture Analyser from Stable Micro Systems. A 6 mm diameter stainless steel probe is inserted 10 mm into sample at a speed of 1 mm/s; each sample of product is tested five times in separate locations of the packed product. The peak force measured is recorded as firmness (N). An average of the results is reported.

Yield stress may be evaluated using a Brookfield rotational viscometer with 4-sided stainless steel blade (6 mm diameter, 12 mm high) inserted to a depth of 19 mm into the sample and rotated at 0.5 rpm for 30 seconds. The height of the sample is at least 30 mm. The product is tested three times per sample in different locations. An average of the results is reported as stress (Pa).

In various embodiments the processed cheese has a yield stress of less than 11000, 10500, 10000, 9500, 9000, 8500, 8000, 7500, 7000, 6500, 6000, 5500, 5000, 4500, 4000, 3500, 3000, 2500, 2000, 1500, 1000 or less than 500 Pa, and various ranges can be selected from between any two of these values, for example from about 500 to about 11000 Pa, about 2000 to about 10000 Pa, about 2000 to about 9000 Pa, about 2000 to about 7500 Pa, about 2000 to about 6000 Pa, about 3000 to about 10000 Pa, about 3000 to about 9000 Pa, about 3000 to about 7500 Pa, or about 3000 to about 6000 Pa.

In one aspect, the invention provides a method for preparing a cheese, preferably a processed cheese, the method comprising
a) providing a cheese composition comprising
   i. a milk protein composition of the invention or a milk protein composition prepared by a method of the invention, and
   ii. one or more additional ingredients, and
b) heating the cheese composition at a temperature of at least about 70° C. to produce the cheese.

In various embodiments, the method comprises mixing the composition.

### 8. Method of Preparing Food Product

In a further aspect, the invention provides a method for preparing a protein-containing food product, the method comprising
a) providing a milk protein composition of the invention or a milk protein composition prepared by a method described herein, and
b) mixing with one or more additional ingredients to produce the protein-containing food product.

In various embodiments, the protein containing food product may be prepared by a method comprising providing a milk protein composition of the invention, and mixing with at least one source of lipid. In various embodiments, the protein containing food product may be prepared by a method comprising providing a milk protein composition of the invention, and mixing with at least one source of carbohydrate. In various embodiments, the protein containing food product may be prepared by a method comprising providing a milk protein composition of the invention, and mixing with at least one source of lipid and at least one source of carbohydrate. Other steps for preparing and packaging a protein containing food product will depend on the product to be produced and will be known to a skilled worker.

In various embodiments the method may comprise providing an aqueous composition comprising the milk protein composition. In some embodiments the method may comprise reconstituting a powdered milk protein composition, optionally in combination with one or more additional dry ingredients, to produce the aqueous composition.

### 9. Method of Preparing an Acidified or Fermented Food Product

In a further aspect the invention relates to a method of preparing an acidified protein-containing food product comprising providing a milk protein composition of the invention or prepared by a method of the invention, and performing an acidification step to the composition to produce an acidified protein-containing food product.

In a further aspect the invention relates to a method of preparing a fermented protein-containing food product comprising
a) providing a composition comprising
   i. a milk protein composition of the invention or prepared by a method of the invention, and
   ii. one or more cultures, and
b) incubating the composition for a time sufficient to produce the fermented protein-containing food product.

The composition may be heat treated prior to acidification or fermentation to reduce pathogens or other microorganisms present in the mixture and inducing the β-lactoglobulin-k-casein interaction to modify the texture of the yoghurt. Heat treatments used include low temperature pasteurisation (72° C., 15 sec or 63° C., 30 minutes), high temperature pasteurisation (85° C. for 20-30 min or 90-95° C. for 5 min), sterilisation (110° C. for 30 min or at 130° C. for 40 s) or UHT (135-145° C. for 1-5 s; for example, 145° C. for 1-2 s).

In various embodiments the acidification step comprises addition of one or more food grade acids or acidogens. In various embodiments the food grade acids or acidogens are selected from the group consisting of glucono-delta lactone (GDL), lactic acid, citric acid, malic acid, acetic acid, tartaric acid, fumaric acid, phosphoric acid, hydrochloric acid, sulphuric acid or any combination of any two or more thereof.

In various embodiments the acidification or fermentation step comprises addition of one or more cultures. In various embodiments the cultures are microbial cultures, preferably bacterial cultures. In various embodiments the cultures are selected from the group consisting of Lactobacillus delbrueckii subsp. bulgaricus, Streptococcus thermophilus, Lactobacillus acidophilus, Lacticaseibacillus casei, or cultures from the genera Lactobacillus, Streptococcus, Leuconostoc, Lactococcus or Bifidobacterium.

In various embodiments the method comprises incubating the composition for a time sufficient to produce the fermented protein-containing food product. A sufficient time may be the time required to produce a desired firmness, viscosity and/or acidity. A person skilled in the art can readily determine the required time to produce the fermented product depending on the specific culture(s) used, the conditions of incubation (e.g. temperature), the nature of the aqueous composition (e.g. protein content, pH) and the desired attributes of the final product (e.g. acidity, firmness, viscosity).

In various embodiments, the acidified or fermented food product can be smoothed or sheared to break up the gel structure. Smoothing allows a pourable consistency. Equipment used to do this smoothing can be anything that applies shear to the product, including a back-pressure valve, a rotor stator shear pump, a homogeniser, or inline sieves or strainers.

### 10. Method of Preparing Food Product by In-Line Proteolysis

In an alternative aspect, the invention generally relates to a method of producing a protein-containing food product, the method comprising providing a composition comprising calcium-depleted milk protein and one or more additional ingredients, and subjecting the milk protein in the composition to proteolysis to produce the protein-containing food product.

This method may be used to produce any protein-containing food product disclosed herein.

In various embodiments, the method comprises providing a milk protein composition comprising milk protein, preferably comprising a milk protein concentrate, a milk protein isolate, or a combination thereof, the milk protein composition comprising
a) at least about 40% total protein by weight relative to the dry matter in the composition,
b) less than about 2 g calcium per 100 g total protein, and/or less than about 1.4 g calcium per 100 g of the dry matter in the composition.

In one aspect, the invention provides a protein-containing food product prepared by the above method.

In various embodiments, the milk protein or milk protein composition may comprise a milk protein concentrate (MPC), a milk protein isolate (MPI), a caseinate, casein, a casein co-precipitate, a retentate obtained by ultrafiltration or microfiltration of milk, or any combination of any two or more thereof. In various embodiments, the milk protein may comprise a milk protein concentrate (MPC), a milk protein isolate (MPI), or a combination thereof. In various embodiments, the milk protein may comprise a milk protein concentrate (MPC) or a milk protein isolate (MPI).

In various embodiments, the milk protein composition comprises at least about 40%, about 45%, about 50%, about 60%, about 70%, about 80%, about 90% or at least about 95% by weight total protein relative to the dry matter in the composition, and various ranges may be selected from between any two of those ranges. In various embodiments the composition may comprise from about 40% to about 99%, about 40 to about 90% or about 40 to about 80% by weight total protein relative to the dry matter in the composition.

In various embodiments the milk protein or milk protein composition may comprise at least about 10, 20, 30, 40, 50, 55, 60, 65, 70, 75, 80, 85, 90, 95, 99 or 100% by weight casein relative to dry matter, and various ranges may be selected from between any two of these values, for example, from about 10 to about 100%, about 40 to about 100, about 50 to about 100, about 60 to about 100, about 70 to about 100, about 75 to about 100, or about 80 to about 100%, about 10 to about 90, about 40 to about 90, about 50 to about 90, about 60 to about 90, about 70 to about 90, about 75 to about 90, or about 80 to about 90%, by weight casein relative to dry matter.

In various embodiments the milk protein or milk protein composition may comprise whey protein. In various embodiments, the milk protein or milk protein composition may comprise from about 1 to about 50%, about 1 to about 40%, about 1 to about 30%, or about 1 to about 20% by weight whey protein relative to dry matter.

In various embodiments the whey proteins may comprise or be provided by an ingredient comprising a whey protein concentrate, whey protein isolate or a combination thereof. Other suitable sources of whey protein known in the art may be used.

In various embodiments, the milk protein composition comprises less than about 2 g calcium per 100 g total protein, or less than about 1.9, 1.8, 1.6, 1.5, 1.4, 1.2, 1, 0.8, 0.75, 0.6, 0.5, 0.4, 0.3, 0.2 or 0.1 g calcium per 100 g total protein, and various ranges may be selected from between any two of these values, for example, from about 0.1 to about 2, about 0.5 to about 2, about 1 to about 2, about 0.1 to about 1.5, about 0.5 to about 1.5, or about 1 to about 1.5 g calcium per 100 g total protein.

In various embodiments, the milk protein composition may comprise less than about 1.4 g calcium per 100 g of the dry matter in the composition, or less than about 1.3, 1.2, 1.1, 1.0, 0.9, 0.8, 0.7, 0.6, 0.5, or 0.4 g calcium per 100 g of the dry matter in the composition.

The method further comprises mixing the milk protein composition with one or more additional ingredients to produce an aqueous intermediate composition comprising from about 0.5 to about 20% by weight total protein.

In various embodiments the aqueous intermediate composition may comprise at least about 2, 3, 4, 5, 6, 7, 8, 9, 10, 12, 14, 15, 16, 18, or at least about 20% by weight total protein relative to the dry matter in the composition, and various ranges may be selected from between any two or these values, for example, from about 2 to about 20, 4 to about 20, 5 to about 20, 8 to about 20, 2 to about 18, 4 to about 18, 5 to about 18, or about 8 to about 20% by weight total protein.

The one or more additional ingredients may comprise any ingredient

described herein, in particular, any ingredient disclosed in any one of paragraphs [0177] to [0193].

In various embodiments the one or more additional ingredients may comprise skim milk or skim milk powder.

In various embodiments the method comprises subjecting the aqueous intermediate composition to the action of one or more proteolytic enzymes. Any proteolytic enzyme described herein may be used under any conditions described herein, for example the enzymes and conditions described in any one of paragraphs [00141] to [00155] or in the Examples.

In some embodiments the method comprises inactivating the one or more proteolytic enzymes. Any method described herein to inactivate the proteolytic enzyme may be used. In other embodiments, a specific inactivation is unnecessary and the one or more proteolytic enzymes are inactivated by subsequent processing steps in the preparation of the protein-containing food product, for example, heating, incubating the composition with one or more cultures to produce a fermented food product or acidifying the composition to produce an acidified food product.

In various embodiments the method may comprise adjusting the pH to a desired pH for optimal activity of the one or more proteolytic enzymes or to improve solubility of one or more of the ingredients in the aqueous intermediate composition.

In various embodiments, the total milk protein may have a peptide molecular weight profile corresponding to the following molecular weight distribution:
a) from about 20%, 25%, 30%, 35%, 40%, 45%, or 50% to about 79% of peptides having a molecular weight of greater than about 20 kDa,
b) from about 15, 20, 25, 30, 35, 40, 45, 50 or about 55% by weight of peptides having a molecular weight of from about 5 to about 20 kDa,
c) from about 2%, 3%, 4%, 5%, 10%, 12%, 14%, 16%, 18% to about 20% by weight of peptides having a molecular weight of from about 1 to about 5 kDa, and
d) from about 2%, 3%, 4%, 5%, 10%, 15% to about 20% by weight of peptides having a molecular weight of less than about 1 kDa.

In various embodiments, the total milk protein may have a peptide molecular weight profile corresponding to the following molecular weight distribution:
a) from about 20% to about 79% of peptides having a molecular weight of greater than about 20 kDa,
b) from about 15% to about 54% by weight of peptides having a molecular weight of from about 5 to about 20 kDa,
c) from about 2% to about 17% by weight of peptides having a molecular weight of from about 1 to about 5 kDa, and
d) from about 2% to about 20% by weight of peptides having a molecular weight of less than about 1 kDa.

In various embodiments, the total milk protein may comprise
a) less than about 79%, 78%, 77%, 76%, 75%, 70%, 65%, 60%, 55%, 50%, 45%, or 40% peptides having a molecular weight of greater than about 20 kDa, and
b) from about 15 to about 55%, about 15% to about 50%, about 15% to about 45%, about 15% to about 40%, about 15% to about 35%, 20% to about 50%, about 20% to about 45%, about 20% to about 40%, about 20% to about 35%, 25% to about 50%, about 25% to about 45%, about 25% to about 40%, about 25% to about 35%, 30% to about 50%, about 30% to about 45%, or about 30% to about 40% peptides having a molecular weight within the range of about 5 to about 20 kDa.

In various embodiments, the total milk protein may comprise

a) less than about 79%, 78%, 77%, 76%, 75%, 70%, 65%, 60%, 55%, 50%, 45%, or 40% peptides having a molecular weight of greater than about 20 kDa, and
b) less than about 30%, less than about 28%, less than about 25%, or less than about 20% peptides having a molecular weight of less than about 5 kDa.

In various embodiments, the total milk protein may comprise
a) less than about 79%, 78%, 77%, 76%, 75%, 70%, 65%, 60%, 55%, 50%, 45%, or 40% peptides having a molecular weight of greater than about 20 kDa, and
b) less than about 20%, less than about 18%, less than about 16%, less than about 14%, or less than about 12% peptides having a molecular weight within the range of about 1 to about 5 kDa.

In various embodiments, the total milk protein may comprise
a) less than about 79%, 78%, 77%, 76%, 75%, 70%, 65%, 60%, 55%, 50%, 45%, or 40% peptides having a molecular weight of greater than about 20 kDa, and
b) less than about 20%, less than about 15%, or less than about 10% peptides having a molecular weight of less than about 1 kDa.

In various embodiments the protein-containing food product comprises
a) less than about 3, 2.75, 2.5, 2.25, 2., 2.1, 2, 1.9, 1.8, 1.5, 1, or 0.5 g calcium per 100 g casein in the food product, or from about 0.5 to about 3 g calcium per 100 g casein in the food product,
b) less than about 3, 2.75, 2.5, 2.25, 2., 2.1, 2, 1.9, 1.8, 1.7, 1.6, 1.5, 1.4, 1.3, 1.2, 1.1, 1 g calcium per 100 g total protein in the food product, or from about 1 to about 3 g calcium per 100 g total protein in the food product, and/or
c) less than about 2, 1.75, 1.5, 1.4, 1.3, 1.2, 1.1, 1, 0.9, 0.8, 0.5 g calcium per 100 g of the dry matter in the food product, or from about 0.5 to about 2 g calcium per 100 g of the dry matter in the food product.

In various embodiments the protein-containing food product is an acidified food product. The acidified food product may be any acidified food product described herein.

In one embodiment the method comprises subjecting the aqueous intermediate composition to the action of one or more proteolytic enzymes, and optionally inactivating the one or more proteolytic enzymes, then acidifying the aqueous intermediate composition to produce the acidified protein-containing food product. In an alternative embodiment, the proteolysis and acidification steps are reversed such that the method comprises acidifying the aqueous intermediate composition, then subjecting the aqueous intermediate composition to the action of one or more proteolytic enzymes, and optionally inactivating the one or more proteolytic enzymes to produce the acidified protein-containing food product.

In various embodiments the protein-containing food product is a fermented food product. The fermented food product may be any fermented food product described herein.

In one embodiment the method comprises subjecting the aqueous intermediate composition to the action of one or more proteolytic enzymes, and optionally inactivating the one or more proteolytic enzymes, then adding one of more cultures to the aqueous intermediate composition and incubating for a time sufficient to produce the fermented protein-containing food product. In an alternative embodiment, the proteolysis and fermentation steps are reversed such that the method comprises adding one of more cultures to the aqueous intermediate composition and incubating for a sufficient time, then subjecting the aqueous intermediate composition to the action of one or more proteolytic enzymes, and optionally inactivating the one or more proteolytic enzymes to produce the fermented protein-containing food product.

In various embodiments the method comprises adding a casein-containing composition or a whey-containing composition, or a mixture thereof to the milk protein composition or the aqueous intermediate composition to adjust the ratio of casein to whey to a desired level. In various embodiments the adjustment may be performed before proteolysis, after proteolysis, before inactivation of the proteolytic enzyme(s), after inactivation of the proteolytic enzyme(s), before or after adding one or more cultures, before or after incubating the aqueous intermediate composition to produce a fermented product, or before or after acidifying.

In various embodiments the method may further comprise adding one or more further additional ingredients. In various embodiments the one or more further additional ingredients may be added before proteolysis, after proteolysis, before inactivation of the proteolytic enzyme(s), after inactivation of the proteolytic enzyme(s), before or after adding one or more cultures, before or after incubating the aqueous intermediate composition to produce a fermented product, or before or after acidifying. For example, it may be desirable to add certain ingredients after the proteolysis to avoid any undesirable effects of the proteolytic enzyme on those ingredients.

### EXAMPLES

### 1. Example 1

This example describes preparation of milk protein compositions of the invention.

MPCs with reduced calcium were prepared according to the method described in U.S. Pat. No. 7,157,108.

The following MPC powders were recombined as detailed in Table 1 in water at 25-55° C. for 1 hour using an overhead stirrer to produce an aqueous composition comprising 10% by weight protein.
MPC A (69.9% protein, 2180 mg calcium per 100 g powder)
MPC B (70% protein, 326 mg calcium per 100 g powder)
MPC C (50% protein, 401 mg calcium per 100 g powder)

Additionally, fresh MPI retentates with reduced calcium levels were prepared according to the method described in U.S. Pat. No. 7,157,108.

The following MPI powders were recombined as detailed in Table 1 in water at 25-55° C. for 1 hour using an overhead stirrer to produce an aqueous composition comprising about 6.61-6.82% by weight protein.
MPI A (6.82% protein, 2720 mg calcium per 100 g protein)
MPI B (6.95% protein, 82 mg calcium per 100 g protein)

The compositions were cooled to 5° C. and an appropriate dose (according to manufacturer's recommendations) of DuPont Food Pro PNL enzyme was added.

The composition was incubated at 5° C. at neutral pH for 30 min to allow protein hydrolysis to occur.

The composition was then heated to 90° C. over 8 to 10 min and held for 5 min to inactivate the enzyme then cooled to ambient temperature.

A summary of the MPCs and MPIs including ingredients, composition, conditions for hydrolysis and a description of the properties of the partially hydrolysed product are provided in Table 1 below.

TABLE 1
Formulations, compositions, and conditions for hydrolysis of dry blended
MPCs or fresh MPI retentates varying in degree of calcium depletion.

| | | | | |
|---|---|---|---|---|
| 1 | 2 | 3 | 4 | 5 |

Ingredients (% by weight)

| | | | | | |
|---|---|---|---|---|---|
| MPC A | 100 | | 55 | 32 | |
| MPC B | | | 45 | 68 | 100 |
| MPC C | | 100 | | | |
| MPI A | | | | | |
| MPI B | | | | | |
| Protein/ | 70 | 50 | 70 | 70 | 70 |
| total solids | | | | | |

Composition (% by weight)

| | | | | | |
|---|---|---|---|---|---|
| Total protein | 10 | 10 | 10 | 10 | 10 |
| (before drying) | | | | | |
| Total solids | 13.67 | 19.3 | 13.65 | 13.64 | 13.62 |
| (% by weight, | | | | | |
| before drying) | | | | | |
| Calcium | 3114 | 800 | 1923 | 1313 | 465 |
| (mg/100 g | | | | | |
| total protein | | | | | |
| dry basis) | | | | | |
| Calcium | 3893 | 1000 | 2403 | 1641 | 581 |
| (mg/100 g | | | | | |
| casein | | | | | |
| dry basis) | | | | | |

Hydrolysis conditions

| Enzyme | DuPont FoodPro PNL | | | | |
|---|---|---|---|---|---|
| Enzyme | 0.015 | 0.015 | 0.015 | 0.015 | 0.015 |
| dosage (%) | | | | | |

Product characteristics

| | | | | | |
|---|---|---|---|---|---|
| Appearance | Aggregation | Homogeneous | Small, very | Small, very | Homogeneous |
| | upon heat | fluid solution, | soft | soft | fluid solution, |
| | inactivation. | no aggregation | aggregates. | aggregates. | no aggregation |
| | Curd-like. | | Flowable. | Flowable | |
| | Not processed | | | | |
| | further | | | | |
| Degree of | — | <0.1 | 0.4 | <0.1 | 0.5 |
| hydrolysis | | | | | |
| (%) | | | | | |

MW profile (%)

| | | | | | |
|---|---|---|---|---|---|
| <1 kDa | — | 6.99 | 5 | 5.35 | 2.79 |
| 1-5 kDa | — | 5.3 | 7.37 | 7.29 | 6.54 |
| 5-20 kDa | — | 32.01 | 35.2 | 35.73 | 32.83 |
| >20 kDa | — | 55.71 | 52.44 | 51.62 | 57.84 |

| | 6 | 7 | 8 | 9 |
|---|---|---|---|---|
| Ingredients (% by weight) | | | | |
| MPC A | | | | |
| MPC B | | | | |
| MPC C | | | | |
| MPI A | 100 | 32 | 22 | 8 |
| MPI B | | 68 | 88 | 92 |
| Protein/ | 90 | 90 | 90 | 90 |
| total solids | | | | |
| Composition (% by weight) | | | | |
| Total protein | 6.82 | 6.67 | 6.64 | 6.61 |
| (before drying) | | | | |
| Total solids | 7.54 | 7.60 | 7.61 | 7.62 |
| (% by weight, | | | | |
| before drying) | | | | |
| Calcium | 2721 | 926 | 671 | 293 |
| (mg/100 g | | | | |
| total protein | | | | |
| dry basis) | | | | |
| Calcium | 3266 | 1111 | 805 | 352 |
| (mg/100 g | | | | |
| casein | | | | |
| dry basis) | | | | |
| Hydrolysis conditions | | | | |
| Enzyme | DuPont FoodPro PNL | | | |
| Enzyme | 0.011 | 0.011 | 0.011 | 0.011 |
| dosage (%) | | | | |
| Product characteristics | | | | |
| Appearance | Large aggregates | Very low | Homogeneous | Homogeneous |
| | formed at 85 C., | amount of | fluid solution, | fluid solution, |
| | not processed | small | no aggregation | no aggregation |
| | further | aggregates. | | |
| Degree of | — | <0.1 | 0.3 | <0.1 |
| hydrolysis | | | | |
| (%) | | | | |
| MW profile (%) | | | | |
| <1 kDa | — | 3.2 | 3.52 | 3.48 |
| 1-5 kDa | — | 10.39 | 11.56 | 11.87 |
| 5-20 kDa | — | 43.74 | 47.02 | 48.16 |
| >20 kDa | — | 42.66 | 37.89 | 36.48 |

### 2. Example 2

This example describes preparation of milk protein compositions of the invention.

A combination of the following ingredient powders was recombined in water at 25-55° C. for 1 hour using an overhead stirrer to produce an aqueous composition comprising either 6.9% or 10% by weight protein.
MPC B (70% protein, 326 mg calcium per 100 g MPC)
MPC D (82.4% protein, 270 mg calcium per 100 g MPC)
MPC E (70% protein, 328 mg calcium per 100 g MPC)

The compositions were cooled to 5° C. or heated to 45° C. and an appropriate dose (according to manufacturer's recommendations) of one of the following enzymes was added.
DuPont Food Pro PNL
DSM MaxiPro
Serine protease derived from Fusarium sp.

The compositions were incubated at a temperature and at a pH to allow protein hydrolysis to occur.

The composition was then heated to inactivate the enzyme then cooled to ambient temperature, and for some samples, dried to form a powder.

A summary of the MPCs including ingredients, composition, conditions for hydrolysis and a description of the properties of the partially hydrolysed product are provided in Table 2 below.

TABLE 2
Hydrolysed MPCs including ingredients, composition and conditions for hydrolysis

| Sample | 10 | 11 | | 12 | | 13 | | 14 | | 15 | |
|---|---|---|---|---|---|---|---|---|---|---|---|
| MPC D | | | | | | 100 | | | | | |
| MPC B | 100 | 100 | | 100 | | | | 100 | | 100 | |
| MPC E | | | | | | | | | | | |
| Total protein | 10 | 10 | | 10 | | 10 | | 10 | | 10 | |
| (% by weight, | | | | | | | | | | | |
| before drying) | | | | | | | | | | | |
| Total solids | 13.65 | 13.65 | | 13.65 | | 11.58 | | 13.65 | | 13.65 | |
| (% by weight, | | | | | | | | | | | |
| before drying) | | | | | | | | | | | |
| Enzyme dosage | 0 | 0.038 | | 0.05 | | 0.015 | | 0.015 | | 0.015 | |
| Calcium | 466 | 466 | | 466 | | 328 | | 466 | | 466 | |
| (mg/100 g | | | | | | | | | | | |
| total protein | | | | | | | | | | | |
| dry basis) | | | | | | | | | | | |
| Calcium | 583 | 583 | | 583 | | 410 | | 583 | | 583 | |
| (mg/100 g | | | | | | | | | | | |
| casein | | | | | | | | | | | |
| dry basis) | | | | | | | | | | | |
| Enzyme | — | Serine | | DSM | | DuPont | | DuPont | | DuPont | |
| | | protease | | MaxiPro | | FoodPro | | Food Pro | | FoodPro | |
| | | derived from | | | | PNL | | PNL | | PNL | |
| | | Fusarium sp | | | | | | | | | |
| Temperature (° C.) | — | 5 | | 5 | | 5 | | 5 | | 5 | |
| Duration | — | 4 | hours | 1 | hour | 30 | minutes | 30 | minutes | 30 | minutes |
| Time to heat to | | 8-10 | min | 8-10 | min | 8-10 | min | 8-10 | min | 8-10 | min |
| inactivation | | | | | | | | | | | |
| temperature | | | | | | | | | | | |
| Inactivation conditions | — | 90° C., | 5 min | 80° C., | 1 min | 90° C., | 5 min | 90° C., | 5 min | 90° C., | 5 min |

| | | | | | | |
|---|---|---|---|---|---|---|
| Appearance | | Homogenous | Homogenous | Homogenous | Homogenous | Homogenous |
| | | fluid | fluid | fluid | fluid | fluid |
| | | solution, | solution, | solution, | solution, | solution, |
| | | no aggregates | no aggregates | no aggregates | no aggregates | no aggregates |
| Degree of hydrolysis (%) | <0.1 | 1.4 | 1.2 | 0.5 | 0.1 | 0.2 |

MW profile (%)

| | | | | | | |
|---|---|---|---|---|---|---|
| <1 kDa | 3 | 11 | 16 | 3 | 3 | 2 |
| 1-5 kDa | 1 | 6 | 7 | 7 | 3 | 4 |
| 5-20 kDa | 8 | 47 | 48 | 33 | 22 | 28 |
| >20 kDa | 88 | 36 | 28 | 58 | 72 | 65 |

| Sample | 16 | | 17 | | 18 | | 19 | |
|---|---|---|---|---|---|---|---|---|
| MPC D | | | | | | | | |
| MPC B | 100 | | 100 | | 100 | | | |
| MPC E | | | | | | | 100 | |
| Total protein | 10 | | 10 | | 10 | | 6.9 | |
| (% by weight, | | | | | | | | |
| before drying) | | | | | | | | |
| Total solids | 13.65 | | 13.65 | | 13.65 | | 9.4 | |
| (% by weight, | | | | | | | | |
| before drying) | | | | | | | | |
| Enzyme dosage | 0.015 | | 0.015 | | 0.015 | | 0.015 | |
| Calcium | 466 | | 466 | | 466 | | 471 | |
| (mg/100 g | | | | | | | | |
| total protein | | | | | | | | |
| dry basis) | | | | | | | | |
| Calcium | 583 | | 583 | | 583 | | 589 | |
| (mg/100 g | | | | | | | | |
| casein | | | | | | | | |
| dry basis) | | | | | | | | |
| Enzyme | DuPont | | DuPont | | DuPont | | DuPont | |
| | Food Pro | | FoodPro | | FoodPro | | FoodPro | |
| | PNL | | PNL | | PNL | | PNL | |
| Temperature (° C.) | 5 | | 5 | | 5 | | 45 | |
| Duration | 1 | hour | 30 | minutes | 2 | hours | 3 | minutes |
| Time to heat to | 8-10 | min | 8-10 | min | 8-10 | min | 2-4 | min |
| inactivation | | | | | | | | |
| temperature | | | | | | | | |
| Inactivation conditions | 90° C., | 5 min | 90° C., | 5 min | 90° C., | 5 min | 95° C., | 5 min |

| Appearance | Homogenous | Homogenous | Homogenous | Homogenous |
|---|---|---|---|---|
| | fluid | fluid | fluid | fluid |
| | solution, | solution, | solution, | solution, |
| | no aggregates | no aggregates | no aggregates | no aggregates |
| Degree of hydrolysis (%) | 0.2 | 1.1 | 1.3 | <0.1% |
| MW profile (%) | | | | |
| <1 kDa | 3 | 6 | 8 | 3 |
| 1-5 kDa | 4 | 4 | 4 | 4 |
| 5-20 kDa | 26 | 33 | 38 | 25 |
| >20 kDa | 67 | 57 | 50 | 68 |

### Example 2A

MPC compositions were made according to Example 2.

The compositions were cooled and an appropriate dose of one of the following enzymes was added.
DuPont Food Pro PNL
Biocatalysts Promod™ 523MDP

The composition was incubated at a temperature and at a pH to allow protein hydrolysis to occur.

The composition was then heated to inactivate the enzyme then cooled to ambient temperature.

A summary of the MPCs including ingredients, composition, conditions for hydrolysis and a description of the properties of the partially hydrolysed product are provided in Table 2A below.

TABLE 2A
Hydrolysed MPCs including ingredients,
composition and conditions for hydrolysis

| Sample | 28 | 29 | 30 | 31 |
|---|---|---|---|---|
| MPC D | 100 | 100 | 100 | 100 |
| Total protein | 10 | 10 | 10 | 14 |
| (% by weight, | | | | |
| before drying) | | | | |
| Total solids | 11.57 | 11.57 | 11.57 | 16.99 |
| (% by weight, | | | | |
| before drying) | | | | |
| Enzyme | 0.01 | 0.04 | 0.074 | 0.021 |
| dosage (%) | | | | |
| Calcium (mg/ | 328 | 328 | 328 | 328 |
| 100 g total | | | | |
| protein dry | | | | |
| basis) | | | | |
| Calcium (mg/ | 410 | 410 | 410 | 410 |
| 100 g casein | | | | |
| dry basis) | | | | |
| Enzyme | Biocatalysts | Biocatalysts | Biocatalysts | DuPont |
| | Promod ™ | Promod ™ | Promod ™ | FoodPro |
| | 523MDP | 523MDP | 523MDP | PNL |
| Temperature | 20 | 20 | 20 | 5 |
| (° C.) | | | | |
| Duration | 1 minute | 1 minute | 1 minute | 1 minute |
| Time to heat to | 8-10 min | 8-10 min | 8-10 min | 8-10 min |
| inactivation | | | | |
| temperature | | | | |
| Inactivation | 85° C., | 85° C., | 85° C., | 90° C., |
| conditions | 30 min | 30 min | 30 min | 5 min |
| Appearance | Homo- | Homo- | Homo- | Homo- |
| | genous | genous | genous | genous |
| | fluid | fluid | fluid | thick fluid |
| | solution, | solution, | solution, | solution, |
| | no | no | no | foam |
| | aggregates | aggregates | aggregates | develop- |
| | | | | ment, |
| | | | | no |
| | | | | aggregates |
| Degree of | <0.1% | 0.1 | 0.1 | 1 |
| hydrolysis (%) | | | | |

MW profile (%)

| | | | | |
|---|---|---|---|---|
| <1 kDa | 2 | 4 | 8 | 2 |
| 1-5 kDa | 2 | 10 | 19 | 5 |
| 5-20 kDa | 24 | 45 | 48 | 27 |
| >20 kDa | 72 | 41 | 25 | 66 |

### 3. Example 3

This example describes preparation of milk protein compositions as of the invention and the reduction of intact casein using methods from Anema (SG Anema, The use of “lab-on-a-chip” microfluidic SDS electrophoresis technology for the separation and quantification of milk proteins. International Dairy Journal, Volume 19, Issue 4, April 2009, pg 198-204)

MPC D (82.4% protein, 270 mg calcium per 100 g MPC) powder was recombined in water at 25-55° C. for 1 hour using an overhead stirrer to produce an aqueous composition comprising 6.9% by weight protein.

The compositions were heated to 45° C. and an appropriate dose (according to manufacturer's recommendations) of DuPont Food Pro PNL.

The composition was incubated at a temperature and at a pH to allow protein hydrolysis to occur.

The composition was then heated at 90° C. over 30 seconds and held at 90° C. for 5 min to inactivate the enzyme then cooled to ambient temperature and dried to form a powder.

A summary of the MPCs including ingredients, composition, conditions for hydrolysis and a description of the properties of the partially hydrolysed product are provided in Table 3 below.

TABLE 3
Hydrolysed MPCs including ingredients,
composition and conditions for hydrolysis

| Sample | 20 | 21 | 22 |
|---|---|---|---|
| MPC D | 100 | 100 | 100 |
| Total protein (% by | 6.9 | 6.9 | 6.9 |
| weight before drying) | | | |
| Total solids (% by | 9.4 | 9.4 | 9.4 |
| weight before drying) | | | |
| Enzyme dosage | 0.02 | 0.025 | 0.03 |
| Calcium (mg/100 g | 328 | 328 | 328 |
| total protein dry basis) | | | |
| Calcium (mg/100 g | 410 | 410 | 410 |
| casein dry basis) | | | |
| Enzyme | DuPont | DuPont | DuPont |
| | FoodPro | FoodPro | FoodPro |
| | PNL | PNL | PNL |
| Temperature (° C.) | 45 | 45 | 45 |
| Duration (min) | 3 | 3 | 3 |
| Inactivation | 90° C., | 90° C., | 90° C., |
| conditions | 5 min | 5 min | 5 min |
| Appearance | Homogenous | Homogenous | Homogenous |
| | fluid | fluid | fluid |
| | solution, no | solution, | solution, no |
| | aggregates | no aggregates | aggregates |
| Degree of hydrolysis | <0.1 | 0.5 | 0.7 |
| (%) | | | |

MW profile (%)

| | | | |
|---|---|---|---|
| <1 kDa | 2 | 3.3 | 3 |
| 1-5 kDa | 1 | 7.6 | 8.1 |
| 5-20 kDa | 22 | 40.5 | 41.4 |
| >20 kDa | 74 | 48.6 | 47.5 |

The milk protein composition of the invention in table 3 and the starting material MPC D (un-hydrolysed) were accurately dissolved to 3.5% protein. Samples were analysed for the reduction in intact casein using the 2100 Agilent Bioanalyzer System (Agilent, USA) and were prepared according to the method of Anema. The area under the curve for the casein bands were automatically integrated by the software (2100 Bioanalyzer Expert Software package). The band area was calculated to show a percentage decrease compared to MPC D.

The starting material was known to have a casein: whey ratio of approximately 80:20, the reduction in intact casein on a g protein/100 g total weight basis can be determined. It has been previously found that the band intensities for BSA, LF and IgG are exceptionally low using the [Bioanalyzer] microfluidic chip and might be too low for accurate quantification. This will therefore affect the casein to whey ratio, with the casein being over represented when compared to the total content of the proteins. The Protein 80 kit used in the method has a claimed separation of proteins ranging in molecular mass from ˜5 to 80 kDa and therefore any small peptides or large proteins may not be detected. These factors will consequently produce a casein to whey ratio greater than the generally accepted ratio of 80:20. Due to these factors, we made the assumption that the casein to whey ratio reported using the Bioanalyzer data is likely skewed and therefore the expected casein content was calculated for the control MPC D (82.4 g protein/100 g total weight×0.8 casein). The variation in whey protein detection does not affect the detection and quantification of the casein proteins as the bands are well resolved and captured within the molecular mass range.

TABLE 4
Intact casein of milk protein composition

| | MPC D | | | |
|---|---|---|---|---|
| | (control) | 20 | 21 | 22 |
| Whey (Proportion area | 11.1 | 26.5 | 57.8 | 55.7 |
| under curve) | | | | |
| Casein (Proportion area | 88.9 | 73.5 | 42.2 | 44.3 |
| under curve) | | | | |
| % reduction in intact casein | 0 | 18.0 | 51.9 | 48.8 |
| Intact casein remaining | 65.9 | 54.5 | 31.3 | 32.9 |
| (g/100 g total weight) | | | | |
| Calcium content (mg/ | 410 | 410 | 410 | 410 |
| 100 g intact casein) | | | | |

### 4. Example 4

This example describes the use of a milk protein composition of the invention in the production of a high protein (10 wt %) set yoghurt.

Skim milk powder was recombined in water and an MPC composition prepared as described in Example 2 was added at ambient temperature.

The mixture was heated at 85° C. for 15 minutes, then cooled to 43° C.

The mixture was inoculated with starter culture (Chr Hansen YF-L702).

The mixture was filled into pottles.

The mixture was incubated for approximately 9-16 hours at 43° C. to a final pH of about 4.6 to form yoghurt.

The yoghurt was cooled and stored at 4° C.

The pH, fracture force and firmness of the yoghurts were assessed using methods of the invention. Sensory properties of the yoghurts were also assessed.

The compositions and properties of the yoghurts are described in Table 5.

TABLE 5
Composition of set yoghurts produced using MPCs.

| Yoghurt sample | | | | |
|---|---|---|---|---|
| A | C | D | E | F |
| MPC used (code from Table 2) | | | | |
| 10 | 13 | 17 | 18 | 15 |

Ingredients (weight %)

| | | | | | |
|---|---|---|---|---|---|
| MPC | 70 | 70 | 70 | 70 | 70 |
| Skim milk | 9.18 | 9.18 | 9.18 | 9.18 | 9.18 |
| powder | | | | | |
| Potassium | 0.02 | 0.02 | 0.02 | 0.02 | 0.02 |
| sorbate | | | | | |
| Starter | 0.003 | 0.003 | 0.003 | 0.003 | 0.003 |
| culture | | | | | |
| Water | 20.73 | 20.73 | 20.73 | 20.73 | 20.73 |
| Composition | | | | | |
| Total | 10 | 10 | 10 | 10 | 10 |
| protein | | | | | |
| (% by | | | | | |
| weight) | | | | | |
| Total solids | 17.05 | 17.05 | 17.05 | 17.05 | 17.05 |
| (% by | | | | | |
| weight) | | | | | |
| Calcium | 146 | 138 | 146 | 146 | 146 |
| (mg/100 g) | | | | | |
| Yoghurt | | | | | |
| properties | | | | | |
| pH after | 4.56 | 4.60 | 4.60 | 4.46 | 4.46 |
| fermentation | | | | | |
| Firmness | 5970 | 3099 | 2562 | 1939 | 1915 |
| (g · s) | | | | | |
| Fracture | 328 | 153 | 128 | 93 | 94 |
| force (g) | | | | | |
| Sensory | Very | Relatively | Relatively | Soft | Soft |
| | firm, | soft | soft | texture, | texture, |
| | very | texture, | texture, | acceptable | acceptable |
| | powdery, | acceptable | acceptable | flavour, | flavour, |
| | astringent | flavour, | flavour, | not bitter, | slightly |
| | | not | not | slightly | savoury |
| | | bitter | bitter | savoury | |

### Example 4A

This example describes the use of a milk protein composition of the invention in the production of a high protein (10 wt %) set yoghurt.

Set yoghurts were prepared as described in Example 4 using milk protein compositions prepared as described in Example 2A.

The compositions and properties of the yoghurts are described in Table 5A.

TABLE 5A
Composition and properties of set yoghurts produced using MPCs.

| Yoghurt sample | | |
|---|---|---|
| L | M | N |
| MPC used (code from Table 2A) | | |
| 28 | 29 | 30 |

Ingredients (weight %)

| | | | |
|---|---|---|---|
| MPC | 70 | 70 | 70 |
| Skim milk powder | 9.18 | 9.18 | 9.18 |
| Potassium sorbate | 0.02 | 0.02 | 0.02 |
| Starter culture | 0.003 | 0.003 | 0.003 |
| Water | 20.73 | 20.73 | 20.73 |
| Composition | | | |
| Total protein (% by | 10 | 10 | 10 |
| weight) | | | |
| Total solids (% by | 17.05 | 17.05 | 17.05 |
| weight) | | | |
| Calcium (mg/100 g) | 138 | 138 | 138 |
| Yoghurt properties | | | |
| pH after | 4.55 | 4.46 | 4.38 |
| fermentation | | | |
| Firmness (g · s) | 5247 | 1660 | 581 |
| Fracture force (g) | 251 | 71 | 24 |
| Sensory | Firm, | Soft texture, | Very soft texture, |
| | grainy, | acceptable | acceptable |
| | acceptable | flavour, | flavour, |
| | flavour | not bitter | not bitter |

### Example 4B

This example describes the use of a milk protein composition of the invention in the production of a high protein (12 wt %) set yoghurt.

Set yoghurts were prepared according to the method described in Example 4 above using an MPC prepared as described in Example 3.

The compositions and properties of the yoghurts are described in Table 5B.

TABLE 5B
Composition and properties of set yoghurts.

Yoghurt sample
O
MPC used (code from Table 3)
22

Ingredients (weight %)

| | |
|---|---|
| MPC (powder | 10.96 |
| format) | |
| Skim milk powder | 9.18 |
| Potassium sorbate | 0.02 |
| Starter culture | 0.003 |
| Water | 79.84 |
| Composition | |
| Total protein (% by | 12 |
| weight) | |
| Total solids (% by | 19.18 |
| weight) | |
| Calcium (mg/100 g) | 156 |
| Yoghurt | |
| properties | |
| pH after | 4.64 |
| fermentation | |
| Firmness (g · s) | 2510 |
| Fracture force (g) | 118 |
| Sensory | Overall acceptable sensory properties. |
| | Slightly thick doughy texture, slightly |
| | powdery, slightly salty & bitter |

### 5. Example 5

This example describes the preparation of stirred yoghurts comprising milk protein compositions according to the invention.

Stirred yoghurts were prepared by the following method.
1. An MPC composition prepared according to Example 2 was added to water to reconstitute and thoroughly mix the powders.
2. The yoghurt mix was given a traditional yoghurt milk heat treatment.
3. The mix was cooled to 43° C.
4. Starter culture was added and stirred until well combined.
5. The inoculated mixture was incubated at 43° C. to a pH of approximately 4.6 (about 14 hours).
6. The yoghurts were cooled to 20° C. and sheared to break up the gel and produce stirred yoghurt.
7. Yoghurts were packed and stored at 4° C.

The ingredients, composition, conditions for manufacture and properties of the stirred yoghurts are summarised in Table 6.

Reference samples, containing MPCs that had not been subjected to partial hydrolysis were produced. Reference sample 1 (Ref 1) was produced using MPC A. Reference sample 2 (Ref 2) was produced using MPC B.

TABLE 6
Composition of stirred yoghurts produced using MPCs
varying in molecular weight profile.

| | Yoghurt sample | | |
|---|---|---|---|
| | G | H | I |
| | MPC ingredient | | |
| | Ref1 | Ref2 | 19—See Table 2 |
| MPC powder | 10.05 | 10.13 | 10 |
| Skim milk powder | 9.18 | 9.18 | 9.18 |
| Potassium sorbate | 0.02 | 0.02 | 0.02 |
| Starter culture | 0.003 | 0.003 | 0.003 |
| Water | 80.74 | 80.67 | 80.8 |
| Total protein (% by weight) | 10 | 10 | 10 |
| Total solids (% by weight) | 18.43 | 18.54 | 18.38 |
| Calcium (mg/100 g) | 307 | 146 | 114 |
| pH after fermentation | 4.59 | 4.56 | 4.54 |
| Titratable acidity | 1.67 | 1.56 | 1.61 |
| Smoothing | Y-tron | Y-tron | Y-tron |
| Viscosity (mPa · s) at 50 s⁻¹ | 3401 | 1985 | 13 |

### 6. Example 6

This example described sensory evaluation of the stirred yoghurts produced in Example 5.

An expert sensory panel (n=12) used quantitative descriptive sensory analysis to capture the sensory profile of the yoghurts. Sensory attributes were defined and intensities were scored on an un-structured 150 mm line scale anchored from absent to intense. All data was collected using Compusense®20 and analysed using Minitab®18. The yoghurts were stored at 4° C. until evaluation and all stirred gently and in the same way during sub-sampling to ensure consistent sample presentation. All samples were served at 20° C. in clear sample cups under red lights identified by random 3-digit codes. The panellists had a selection of palate cleansers to use including water, soda water, plain water crackers, apple and cucumber.

TABLE 7
Quantitative descriptive analysis of yoghurts produced using
MPCs of the invention compared with unhydrolyzed MPC

| Yoghurt sample | | | |
|---|---|---|---|
| (see Table 6) | G | H | I |
| Texture attributes | | | |
| Thickness | 118.9^{a} | 105.4^{b} | 33.9^{c} |
| Flavour attributes | | | |
| Bitter | 4.5^{a} | 4.2^{a} | 2.1^{a} |
| Milky/Creamy | 55.6^{a} | 53.6^{a} | 39.3^{b} |
| Cultured | 61.8^{a} | 62.2^{a} | 61.8^{a} |
| Savoury | 0.0^{a} | 4.8^{a} | 5.7^{a} |

Values with different superscript letters within a row denote significant differences (P<0.05) between the samples.

Sensory evaluation of the yoghurt prepared with the present invention (sample I) demonstrated that the invention enables production of a very thin, drinkable yoghurt without impacting flavour profile. Sample I was rated as less thick. Sample I had a similar bitterness rating to the reference yoghurts and a similar savoury flavour to Ref 2.

### 7. Example 7

This example demonstrates preparation of a milk protein composition comprising sodium caseinate and use of the composition to produce yoghurt.

Sodium caseinates were prepared according to the method described in Example 1 above.

The sodium caseinate comprised 91.9% protein, 40 mg calcium/100 g caseinate.

The caseinates were used to prepare set yoghurts using the method described in Example 4.

The composition and properties of the caseinates is described in Table 8 below. The composition and properties of the set yoghurts are summarised in Table 9.

TABLE 8
Sodium caseinates including
composition and conditions for hydrolysis

| Sample | 50 | 51 |
|---|---|---|
| Sodium Caseinate | 100 | 100 |
| Total protein (% by weight) | 10 | 10 |
| Total solids (% by weight) | 10.39 | 10.39 |
| Casein:whey | 100:0 | 100:0 |
| Calcium (mg/100 g total | 41.6 | 41.6 |
| protein) | | |
| Calcium (mg/100 g casein) | 41.6 | 41.6 |
| Enzyme | — | DSM MaxiPro |
| Enzyme dosage (%) | — | 0.05 |
| Temperature (° C.) | — | 5 |
| Duration | — | 1 hour |
| Inactivation conditions | — | 80° C., 1 min |
| Appearance | Homogenous | Homogenous |
| | fluid solution, | fluid solution, |
| | no aggregates | no aggregates |
| Degree of hydrolysis (%) | 0.4 | 1.9 |
| MW profile (%) | | |
| <1 kDa | 1.2 | 19.75 |
| 1-5 kDa | 1.15 | 5.36 |
| 5-20 kDa | 14.49 | 53.23 |
| >20 kDa | 83.16 | 21.66 |

TABLE 9
Composition of set yoghurts
produced using sodium caseinates.

| | | |
|---|---|---|
| Yoghurt sample | J | K |

Ingredients (weight %)

| | | |
|---|---|---|
| Hydrolysed sodium | 70 | 70 |
| caseinate | (caseinate 50) | (caseinate 51) |
| Skim milk powder | 9.18 | 9.18 |
| Potassium sorbate | 0.02 | 0.02 |
| Starter culture | 0.003 | 0.003 |
| Water | 20.73 | 20.73 |

Composition

| | | |
|---|---|---|
| Total protein (% by weight) | 10 | 10 |
| Total solids (% by weight) | 17.05 | 17.05 |
| Casein:whey | 80:20 | 80:20 |
| Calcium (mg/100 g) | 138 | 138 |

Yoghurt properties

| | | |
|---|---|---|
| pH after fermentation | 4.48 | 4.47 |
| Titratable acidity | 0.96 | 1.33 |
| Firmness (g · s) | 4993 | 1212 |
| Fracture force (g) | 223 | 58 |
| Sensory | Very firm and | Very soft and |
| | grainy, astringent | slightly grainy. |

### 8. Example 8

This example describes preparation of a food product comprising milk protein compositions of the invention.

MPCs with reduced calcium were prepared according to the method described in U.S. Pat. No. 7,157,108.

The following MPC and SMP powders were recombined as detailed in Table 10 in water at 25-55° C. for 1 hour using an overhead stirrer to produce an aqueous composition comprising 10% by weight protein, 7% protein from MPC B.
MPC B (70% protein, 326 mg calcium per 100 g powder)
Skim milk powder (33% protein, 1240 mg calcium per 100 g powder)

The compositions were cooled to 5° C. and an appropriate dose (according to manufacturer's recommendations) of DuPont Food Pro PNL enzyme was added.

The composition was incubated at 5° C. at neutral pH for 30 min to allow protein hydrolysis to occur.

The composition was then heated to 90° C. and held for 5 min to inactivate the enzyme then cooled to 43° C.

The mixture was inoculated with starter culture (Chr Hansen YF-L702).

The mixture was filled into pottles.

The mixture was incubated for approximately 9-16 hours at 43° C. to a final pH of about 4.6 to form yoghurt.

The yoghurt was cooled and stored at 4° C.

The pH, fracture force and firmness of the yoghurts were assessed using methods of the invention. Sensory properties of the yoghurts were also informally assessed.

A summary of the MPC including ingredients, composition, conditions for hydrolysis and a description of the properties of the partially hydrolysed product are provided in Table 10 below.

These values can be compared in sample A or C in Table 5 as a control.

TABLE 10
Formulations, compositions, and conditions for modified
MPC mixed with skim milk powder prior to hydrolysis.

| | 100 |
|---|---|
| MPC B powder | 9.97 |
| Skim milk powder | 9.18 |
| Water | 80.68 |
| Potassium sorbate | 0.02 |
| Starter culture | 0.003 |
| Protein/total solids | 54 |
| Total protein (% by weight) | 10 |
| Total solids (% by weight) | 18.48 |
| Calcium (mg/100 g) | 146 |
| Calcium (mg/100 g total | 1460 |
| protein dry basis) | |
| Calcium (mg/100 g casein | 1825 |
| dry basis) | |
| Enzyme | DuPont Food Pro PNL |
| Enzyme dosage (%) | 0.01 |
| pH after fermentation | 4.52 |
| Firmness (g · s) | 2983 |
| Fracture force (g) | 157 |
| Sensory | Relatively soft texture, |
| | acceptable flavour, not |
| | bitter |

### Example 8A

This example describes preparation of a food product comprising milk protein compositions of the invention.

The following MPC and SMP powders were recombined as detailed in Table 10A in water at 50-55° C. for 1 hour using an overhead stirrer to produce an aqueous composition comprising 6% or 10% by weight protein.
MPC B (70% protein, 326 mg calcium per 100 g powder)
MPC D (82.4% protein, 270 mg calcium per 100 g powder)
MPC F (81.1% protein, 2160 mg calcium per 100 g powder)
Skim milk powder (33% protein, 1240 mg calcium per 100 g powder)

The compositions were cooled to 5° C. and subjected to enzyme treatment as described in Example 8.

Yoghurts were prepared as described in Example 8.

A summary of the compositions including ingredient composition, conditions for hydrolysis and a description of the properties of the yoghurts are provided in Table 10A below.

TABLE 10A
Formulations, conditions for hydrolysis, yoghurts and yoghurt properties.

| | | | | | | | | | | |
|---|---|---|---|---|---|---|---|---|---|---|
| Sample ID | 101 | 102 | 103 | 104 | 105 | 106 | 107 | 108 | 109 | 110 |

Ingredients/composition

| | | | | | | | | | | |
|---|---|---|---|---|---|---|---|---|---|---|
| MPC B | 13.55 | 13.55 | 6.21 | — | — | — | — | — | — | — |
| MPC D | — | — | — | 9.16 | 9.16 | — | 3.64 | 5.51 | 5.51 | — |
| MPC F | — | — | — | — | — | 4.23 | 0.54 | 3.67 | 3.67 | 8.63 |
| Skim milk powder | 3.00 | 3.00 | 5.70 | 7.50 | 7.50 | 7.85 | 7.85 | 7.50 | 7.50 | 9.18 |
| Potassium sorbate | 0.02 | 0.02 | 0.02 | 0.02 | 0.02 | 0.02 | 0.02 | 0.02 | 0.02 | 0.02 |
| Starter culture | 0.003 | 0.003 | 0.003 | 0.003 | 0.003 | 0.003 | 0.003 | 0.003 | 0.003 | 0.003 |
| Protein/total | 63 | 63 | 52 | 62 | 62 | 52 | 52 | 62 | 62 | 59 |
| solids | | | | | | | | | | |
| Total protein | 10 | 10 | 6 | 10 | 10 | 6 | 6 | 10 | 10 | 10 |
| (% by weight) | | | | | | | | | | |
| Total solids | 15.99 | 15.99 | 11.51 | 16.06 | 16.06 | 11.62 | 11.60 | 16.04 | 16.04 | 16.98 |
| (% by weight) | | | | | | | | | | |
| Calcium (mg/100 g) | 83 | 83 | 92 | 119 | 119 | 191 | 120 | 190 | 190 | 305 |
| Calcium | 833 | 833 | 1532 | 1187 | 1187 | 3190 | 1993 | 1906 | 1906 | 3050 |
| (mg/100 g total | | | | | | | | | | |
| protein dry basis) | | | | | | | | | | |
| Calcium | 1041 | 1041 | 1915 | 1484 | — | 3988 | 2491 | 2383 | 2383 | 3813 |
| (mg/100 g casein | | | | | | | | | | |
| dry basis) | | | | | | | | | | |

Enzyme and degree of hydrolysis

| | | | | | | | | | | |
|---|---|---|---|---|---|---|---|---|---|---|
| Enzyme dosage | 0.11 | 0.15 | 0.07 | 0.11 | 0.15 | 0.07 | 0.07 | 0.11 | 0.11 | 0 |
| (%) | | | | | | | | | | |
| Degree of | 1 | 2 | 1 | 1 | 1 | ND | 2 | 2 | 1 | — |
| Hydrolysis (%) | | | | | | (coagulated) | | | | |

Molecular weight profile (%)

| | | | | | | | | | | |
|---|---|---|---|---|---|---|---|---|---|---|
| <1 kDa | 4 | 5 | 6 | 4 | 4 | — | 6 | 7 | 5 | — |
| 1-5 kDa | 4 | 6 | 4 | 4 | 5 | — | 5 | 5 | 4 | — |
| 5-20 kDa | 23 | 31 | 27 | 23 | 26 | — | 27 | 26 | 23 | — |
| >20 kDa | 70 | 57 | 63 | 69 | 65 | — | 62 | 62 | 69 | — |

Yoghurt properties

| | | | | | | | | | | |
|---|---|---|---|---|---|---|---|---|---|---|
| pH after fermentation | 4.59 | 4.51 | 4.34 | 4.51 | 4.49 | — | 4.24 | 4.51 | 4.40 | 4.52 |
| Firmness (g · s) | 6298 | 5755 | 776 | 4288 | 3157 | — | 442 | 467 | 319 | 6694 |
| Fracture force (g) | 328 | 282 | 35 | 220 | 170 | — | 19 | 15 | 10 | 312 |
| Sensory | Mild | Mild | Mild, | Powdery, | Thick, | — | Milky, | Mild, | Mild, | Very thick/ |
| | flavour, | flavour, | smooth | grainy | smooth, | | smooth | grainy | not | solid, |
| | solid, | solid, | | | not | | | | bitter, | gelled |
| | grainy, | grainy, | | | bitter | | | | thin, | particles, |
| | curd-like | curd-like | | | | | | | slightly | protein |
| | | | | | | | | | grainy | flavour |

### 9. Example 9

This example describes preparation of an acid milk drink using a milk protein composition of the invention comprising an MPC.

Acid milk drinks are prepared using the following method:

Modified MPC 21 powder is added slowly to water 1 at 55° C. that is being stirred at enough speed to create a vortex, but not to cause excessive foam. Speed is reduced and powder is allowed to hydrate for 15 minutes.

Gellan is blended with sugar 1 and added to the MPC mix and hydrated for 1 hour.

Pectin is blended with sugar 2, and added to water 2 then heated to 80° C. under high shear.

MPC mix is added to the pectin solution.

The speed of mixing is increased then citric acid is added; the pH is checked and adjusted to pH 4.2 if required.

Mixture is heat treated at 95° C. for 12 minutes.

Mixture is homogenised at 150/50 bar (single pass)

Composition is packed aseptically at 4° C. or hot filled at 80-85° C. and cool product as quickly as possible.

TABLE 11
Composition of acid milk drinks comprising composition
of the invention comprising MPC

| Ingredients (g) | Ca-depleted modified MPC | Comparative |
|---|---|---|
| Water 1 | 700 | 700 |
| Water 2 | 100 | 100 |
| Modified MPC 21 | 75 | |
| MPC F | | 75 |
| Sugar1 | 45 | 45 |
| Sugar 2 | 5 | 5 |
| Pectin | 5 | 5 |
| Gellan | 0.3 | 0.3 |
| Citric acid | As required | As required |
| Total | 930.3 | 930.3 |

The viscosity, particle size distribution and pH are measured.

The acid milk drink comprising the composition of the invention has an acceptable viscosity, particle size distribution and pH compared with the acid milk drink comprising the comparative acid composition, and has no perceivable undesirable flavours.

### Example 9A

This example describes preparation of an acid milk drink using a milk protein composition of the invention.

Acid milk drinks were prepared using the following method, with reference to the compositions in Table 11A:

MPC powder was added slowly to water 1 at 55° C., which was being stirred at sufficient speed to create a vortex, but not to produce excessive foam. Speed was reduced and powder was allowed to hydrate for 1 hour.

Portion 1 of sugar was added to the MPC mix.

Gellan and pectin were blended with portion 2 of sugar and then added to water 2 at 80° C. under high shear using an ultraturrax. Recombining was done at 10,000 rpm and blending at 15,000 rpm. Mixing was done for 1 minute once the powder mix had all been added in.

The dissolved stabiliser/sugar solution was added to the MPC mix and allowed to mix for 5 minutes.

The mix was cooled to 25° C. and adjusted to pH 4.2 using 10% citric acid solution with shear.

The solution was made up to a final volume of 1000 g with water.

Mixture was heated to 60° C.

Mixture was homogenised at 200/50 bar (single pass)

The mixture was heated to 90° C. for 1 minute. Composition was packed aseptically at 4° C.

TABLE 11A
Composition and properties of acid milk drinks comprising composition of the invention.

| Sample ID | | | | | |
|---|---|---|---|---|---|
| 200 | | 202 | | 204 | |
| (control) | 201 | (control) | 203 | (control) | 205 |

Ingredients (g)

| | | | | | | |
|---|---|---|---|---|---|---|
| Water 1 | 562.7 | 562.7 | 650.7 | 650.7 | 675.4 | 675.4 |
| Water 2 | 200 | 200 | 150 | 150 | 150 | 150 |
| Modified MPC | — | 112 | — | 74 | — | 49.3 |
| 21 (see Table 3) | | | | | | |
| MPC F | 112 | — | 74 | — | 49.3 | — |
| (described in | | | | | | |
| Example 8A) | | | | | | |
| Sugar 1 | 45 | 45 | 45 | 45 | 45 | 45 |
| Sugar 2 | 5 | 5 | 5 | 5 | 5 | 5 |
| Pectin | 5 | 5 | 5 | 5 | 5 | 5 |
| Gellan | 0.3 | 0.3 | 0.3 | 0.3 | 0.3 | 0.3 |
| Citric acid | 122.3 | 134.1 | 78.8 | 87.6 | 57 | 61.7 |
| Total | 1052.3 | 1064.1 | 1008.8 | 1017.6 | 1000 | 1000 |

Composition (g/100 g)

| | | | | | | |
|---|---|---|---|---|---|---|
| Protein | 8.6 | 8.4 | 5.9 | 5.8 | 4.0 | 4.0 |
| Carbohydrates | 5.6 | 5.6 | 5.7 | 5.7 | 5.7 | 5.7 |
| Fat | 0.2 | 0.1 | 0.1 | 0.1 | 0.1 | 0.1 |
| Total solids | 16.4 | 16.3 | 13.2 | 13.1 | 10.9 | 10.8 |
| Calcium (mg) | 214 | 40 | 148 | 27 | 101 | 19 |

Properties of beverage

| | | | | | | |
|---|---|---|---|---|---|---|
| pH before | 6.85 | 6.69 | 6.83 | 6.66 | 6.87 | 6.72 |
| adjustment | | | | | | |
| with citric acid | | | | | | |
| pH after | 4.2 | 4.2 | 4.2 | 4.2 | 4.18 | 4.19 |
| adjustment | | | | | | |
| with citric acid | | | | | | |
| Viscosity | 3680 | 781 | 217.5 | 90 | 20.5 | 21 |
| (mPa · s) Day 1 | | | | | | |
| Viscosity | 9640 | 1840 | 237.5 | 283 | 23.1 | 30.9 |
| (mPa · s) Day 4 | | | | | | |
| Particle size D | 6.9 | 11.8 | 8.1 | 7.1 | 5.3 | 3.6 |
| [4, 3] μm | | | | | | |
| Particle size D | 5.3 | 9.2 | 6.0 | 5.0 | 0.8 | 0.7 |
| [3, 2] μm | | | | | | |
| Informal | Astringent, | Slightly | Astringent, | Slightly | Astringent, | Slightly |
| sensory | cardboard | cheesy, | cardboard | cheesy, | cardboard | cheesy, |
| assessment | flavour | preferred | flavour | preferred | flavour | preferred |
| | | over and | | over and | | over and |
| | | perceived | | perceived | | perceived |
| | | thinner | | thinner | | thinner |
| | | than 200 | | than 202 | | than 204 |

The viscosity, particle size distribution and pH were measured using the following methods.

Viscosity and particle size are determined as described in section 5.

### 10. Example 10

This example describes preparation of an acid milk drink using a milk protein composition of the invention comprising an MPC.

Acid milk drinks were prepared using the following method, with reference to the compositions in Table 12:

Modified MPC powder (sample 21 from Example 3) was added slowly to water 1 at 55° C., which was being stirred at sufficient speed to create a vortex, but not to produce excessive foam. After 15 minutes of mixing, skim milk powder (33% protein, 1240 mg calcium per 100 g powder) and whole milk powder (25% protein, 980 mg calcium per 100 g powder) were added slowly. Speed was reduced and powder was allowed to hydrate for 1 hour.

Portion 1 of sugar was added to the mix.

Gellan and Pectin were blended with portion 2 of sugar and then added to water 2 at 80° C. under high shear using an ultraturrax. Recombining was done at 10,000 rpm and blending at 15,000 rpm. Mixing was done for 1 minute once the powder mix had all been added in.

The dissolved stabiliser/sugar solution was added to the MPC-milk powder-sugar 1 mix and allowed to mix for 5 minutes, then cooled to 25° C. The mix was adjusted to pH 4.2 using 10% citric acid solution with shear and heated to 60° C.

The mix was homogenised at 200/50 bar (single pass). Then heated to 90° C. for 1 minute. The milk drinks were packed aseptically at 4° C.

TABLE 12
Composition and properties of acid milk drinks comprising composition of the invention.

| 6% protein | | | | 9% protein | | | |
|---|---|---|---|---|---|---|---|
| Low fat | | High fat | | Low fat | | High fat | |
| 206 | 207 | 208 | 209 | 210 | 211 | 212 | 213 |

Ingredients (g)

| | | | | | | | | |
|---|---|---|---|---|---|---|---|---|
| Water 1 | 562.7 | 562.7 | 650.7 | 650.7 | 675.4 | 675.4 | 675.4 | 675.4 |
| Water 2 | 200 | 200 | 150 | 150 | 150 | 150 | 150 | 150 |
| MPC 21, | | 36.2 | | 37 | | 73.1 | | 73.9 |
| see Table 3 | | | | | | | | |
| MPC F | 36.2 | | 37 | | 73.1 | | 73.9 | |
| SMP | 93.5 | 93.5 | | | 93.5 | 93.5 | | |
| WMP | | | 123 | 123 | | | 123 | 123 |
| Sugar1 | 45 | 45 | 45 | 45 | 45 | 45 | 45 | 45 |
| Sugar 2 | 5 | 5 | 5 | 5 | 5 | 5 | 5 | 5 |
| Pectin | 5 | 5 | 5 | 5 | 5 | 5 | 5 | 5 |
| Gellan | 0.3 | 0.3 | 0.3 | 0.3 | 0.3 | 0.3 | 0.3 | 0.3 |
| Citric acid | 125.03 | 126.9 | 115.61 | 120.4 | 165.5 | 173 | 162.6 | 166.7 |
| Total | 1072.73 | 1074.6 | 1131.61 | 1136.4 | 1212.8 | 1220.3 | 1240.2 | 1244.3 |

Composition (g/100 g)

| | | | | | | | | |
|---|---|---|---|---|---|---|---|---|
| Protein | 5.8 | 5.7 | 5.4 | 5.3 | 7.6 | 7.5 | 7.3 | 7.2 |
| Carbohydrates | 9.8 | 9.8 | 9.2 | 9.2 | 8.8 | 8.8 | 8.5 | 8.6 |
| Fat | 0.1 | 0.1 | 2.9 | 2.9 | 0.2 | 0.1 | 2.7 | 2.7 |
| Total solids | 17.9 | 17.8 | 19.5 | 19.5 | 19.0 | 18.9 | 21.0 | 20.9 |
| Calcium | 176 | 121 | 173 | 119 | 217 | 118 | 217 | 119 |
| (mg) | | | | | | | | |

Properties of beverage

| | | | | | | | | |
|---|---|---|---|---|---|---|---|---|
| pH before | 6.55 | 6.55 | 6.52 | 6.57 | 6.57 | 6.57 | 6.59 | 6.59 |
| adjustment | | | | | | | | |
| with citric | | | | | | | | |
| acid | | | | | | | | |
| pH after | 3.99 | 4 | 3.99 | 3.99 | 3.99 | 3.99 | 3.98 | 4.01 |
| adjustment | | | | | | | | |
| with citric | | | | | | | | |
| acid | | | | | | | | |
| Viscosity | 195.5 | 169 | 120 | 70 | 1412 | 412 | 928 | 376 |
| (mPa · s | | | | | | | | |
| Day 1 | | | | | | | | |
| Viscosity | 189 | 154 | 166 | 113 | 600 | 135 | 544 | 175 |
| (mPa · s) | | | | | | | | |
| Day 7 | | | | | | | | |
| Particle size D | 8.8 | 65.7 | 9.0 | 8.1 | 24.3 | 10.7 | 9.2 | 8.6 |
| [4,3] μm | | | | | | | | |
| Particle size D | 5.7 | 7.0 | 5.5 | 4.1 | 5.0 | 8.7 | 6.3 | 6.2 |
| [3,2] μm | | | | | | | | |

| | | | | |
|---|---|---|---|---|
| Informal | Acceptable flavour. | Acceptable | Acceptable | Acceptable |
| flavour | | flavour. | flavour | flavour. |
| assessment | | 211 thinner | | 213 thinner |
| | | than 210 | | than 212 |

### 11. Example 11

This example describes preparation of a protein bar using a milk protein composition of the invention.

The following MPCs were used:
MPC D (82.4% protein, 270 mg calcium per 100 g MPC)
MPC F (81.1% protein, 2160 mg calcium per 100 g powder)
Modified MPC D—sample 21 from Example 3

Protein bars were prepared using the following method:

Maltodextrin and MPC were combined. Glucose syrup and glycerine were combined and heated to 50-55° C. Hydrogenated coconut oil and lecithin were heated until the fat melted.

The glucose syrup and glycerine mix was added to the maltodextrin and MPC mix followed by the addition of the oil and lecithin mix. The mix was mixed using a Hobart mixer (Model N-50) at Speed 1 for 90 seconds, and then the bowl was scraped down. Mixing (Speed 2) was continued until a homogenous mass was obtained.

The mix was poured and spread evenly into a bar frame (˜16 mm deep) that was prepared by placing on a sheet of baking paper, sprayed with oil. Gladwrap was sprayed with oil and the wrap was placed oiled side down over the mix, covering the mix completely. The mix was rolled out so that it was flush with the frame, any excess was cut off. The mix was left overnight to set.

The mix was loosened from the frame and cut into bars of 30 mm×100 mm. The bars were packed in foil sachets for storage until use. The composition and properties of the protein bars are described in Table 13.

The fracture force (g), water activity, colour, and sensory attributes of the bars may be measured as describe in section 6.

TABLE 13
Composition and properties of protein bars comprising
composition of the invention.

| | | | |
|---|---|---|---|
| Sample ID | 300 (control) | 301 | 302 (control) |

Ingredients (g)

| | | | |
|---|---|---|---|
| MPC F | 739.88 | | |
| Modified MPC D | | 751.38 | |
| (Sample 21, | | | |
| Example 3) | | | |
| MPC D | | | 731.53 |
| Glucose syrup | 698 | 698 | 698 |
| Glycerine BP 99.9% | 348 | 348 | 348 |
| liquid | | | |
| ConFat 92 | 161.12 | 161.43 | 160.42 |
| (hydrogenated | | | |
| coconut oil) | | | |
| Maltodextrin | 43 | 31.18 | 52.05 |
| Lecithin | 10 | 10 | 10 |

Composition (% by weight)

| | | | |
|---|---|---|---|
| Protein | 29.9 | 30.6 | 30.1 |
| Fat | 9.2 | 9 | 9.1 |
| Carbohydrates | 48.6 | 48.8 | 49.3 |
| Total solids | 90.8 | 91.2 | 91.1 |
| Calcium | 744 | 104 | 102 |

Properties of bar

| | | | |
|---|---|---|---|
| Force (g) day 7 | 1688 | 3118 | 3529 |
| Force (g) day 30 | 4270 | 4473 | 5540 |
| Force (g) 3 month | 6007 | 5535 | 6682 |
| Force (g) 6 month | 6584 | 5582 | 7039 |
| Water activity day 0 | 0.43 | 0.44 | 0.42 |
| Water activity day 7 | 0.48 | 0.49 | 0.47 |
| Water activity day 30 | 0.48 | 0.49 | 0.47 |
| Water activity 3 month | 0.49 | 0.49 | 0.47 |
| Water activity 6 month | 0.50 | 0.50 | 0.49 |
| Colour | | | |
| L* | 86.17 | 86.44 | 87.61 |
| a* | −1.07 | −0.89 | −0.65 |
| b* | 21.72 | 20.79 | 19.85 |
| Colour day 30 | | | |
| L* | 87.67 | 86.62 | 87.84 |
| a* | −0.77 | -0.85 | -0.5 |
| b* | 19.32 | 20.78 | 19.94 |
| Colour 3 month | | | |
| L* | 88.17 | 85.56 | 84.99 |
| a* | 0.38 | 0.76 | 1.85 |
| b* | 21.67 | 26.27 | 25.91 |
| Colour 6 month | | | |
| L* | 86.54 | 83.4 | 83.52 |
| a* | 2.27 | 3.39 | 4.08 |
| b* | 23.06 | 30.28 | 28.52 |
| Sensory day 7 | Powdery, | Slightly | Chewy, |
| | protein | powdery, | protein |
| | flavour, | brothy, | flavour, |
| | soft, less | softer | firm/ |
| | cohesive | than 303 | dense, |
| | than 301 | | slimy |
| Sensory day 30 | Softer than 301, | Salty, firmer | Firm, gluey, |
| | less salty than | than | slimy |
| | 301, crumbly, | 300, softer | |
| | protein flavour | than 303 | |

### 12. Example 12

This example describes preparation of a milk protein composition of the invention and an ambient yoghurt comprising the milk protein composition.

### Preparation of Milk Protein Composition

MPC D was prepared according to the method described in U.S. Pat. No. 7,157,108 to form a composition comprising 6.9% by weight protein.

The composition was heated to 45° C. and an appropriate dose (according to manufacturer's recommendations) of DuPont Food Pro PNL was added.

The composition was heated and inactivated under the conditions outlined in Table 14 below.

A summary of the MPC including ingredients, composition, conditions for hydrolysis and the molecular weight profile of the partially hydrolysed product are provided in Table 14.

TABLE 14
Modified MPC including ingredients,
composition and conditions for hydrolysis
Composition

| | |
|---|---|
| MPC D | 100 |
| Total protein (% by weight) | 6.9 |
| Total solids (% by weight) | 9.4 |
| Enzyme dosage | 0.022 |
| Calcium (mg/100 g total | 347 |
| protein, dry basis) | |
| Calcium (mg/100 g casein, | 434 |
| dry basis) | |
| Enzyme | DuPont FoodPro PNL |

Hydrolysis conditions

| | |
|---|---|
| Temperature (° C.) | 45 |
| Duration (min) | 3 |
| Inactivation conditions | 90° C., 5 min |

Properties

| | |
|---|---|
| Appearance | Homogenous fluid solution, no aggregates |
| Degree of hydrolysis (%) | <0.1 |

MW profile (%)

| | |
|---|---|
| <1 kDa | 3 |
| 1-5 kDa | 7 |
| 5-20 kDa | 39 |
| >20 kDa | 52 |

Ambient yoghurt was prepared as follows.
1. The modified MPC was blended with all powdered ingredients and added to water to reconstitute and thoroughly mix the powders. The solution was mixed for 20 minutes at 60° C.
2. Cream was added and mixed for 10 minutes to produce the yoghurt mix.
3. The yoghurt mix was homogenised at 150/50 bar and given a traditional yoghurt milk heat treatment, then cooled to 43° C.
4. Starter culture (Chr Hansen YF-L702) was added and stirred until well combined. The Inoculated mixture was incubated at 43° C. to a pH of approximately 4.2 (about 14 hours).
5. The yoghurt was cooled to 20° C. and smoothed to break up the gel, then thermalised at 75° C. for 30 seconds and packed.

The ingredients, composition, conditions for manufacture and properties of the stirred yoghurts are summarised in Table 15.

TABLE 15
Composition of ambient yoghurt produced using modified MPC D.
Ingredients (weight %)

| | |
|---|---|
| MPC (from Table 14) | 3.75 |
| Skim milk powder | 8.72 |
| Cream | 7.80 |
| LMA pectin | 0.15 |
| Gellan gum | 0.03 |
| Sugar | 7.00 |
| Starter culture | 0.003 |
| Water | 72.55 |

Composition

| | |
|---|---|
| Total protein (% by weight) | 6 |
| Total solids (% by weight) | 22.45 |
| Calcium (mg/100 g) | 146 |
| pH after fermentation | 4.23 |
| Titratable acidity | 1.19 |
| Smoothing | Back pressure valve (BPV) |
| Viscosity (mPa · s) at 50 s⁻¹ | 398 |
| Sensory | Slightly thick, moderately sour, |
| | moderate cultured flavour, |
| | slightly smooth, slightly creamy |
| | flavour, slightly sweet, |
| | slightly milky flavour, moderately |
| | tangy/citrus flavour |

### 13. Example 13

This example describes preparing a processed cheese lollipop comprising the milk protein composition of the invention.

Processed cheese lollipops were prepared according to the following process:
1. Water was heated to 50° C.,
2. Dry blended powders were added slowly with mixing at 50° C.,
3. Cream cheese and butter were added,
4. The composition was mixed for approximately 4 minutes,
5. The pH of the mixture was adjusted to pH 5.5 using diluted lactic acid solution,
6. The composition was heated to 90° C. for approximately 5 min with stirring,
7. The composition was packed at >65° C. and cooled with 4° C. air flow.

The samples were evaluated:
visually for thickness, ease of processing and filling moulds,
for informal sensory analysis for flavour and texture (using a difference from control test with blind codes, and including a blind repeat of the control),
for yield stress.

Yield stress of processed cheese lollipops was determined at 13° C. as described in section 7.

TABLE 16
Composition of processed cheese lollipops

| Sample ID | 400 | 401 | 402 | 403 | 404 | 405 | 406 | 407 |
|---|---|---|---|---|---|---|---|---|
| % by weight | | | | | | | | |
| MPC F | 5.75 | 6.65 | 8.48 | 10.31 | 5.74 | 5.74 | 5.74 | |
| MPC 21, see | | | | | 0.76 | 2.67 | 4.58 | 8.38 |
| Table 3 | | | | | | | | |
| Total protein | 7.5 | 8.25 | 9.75 | 11.25 | 8.25 | 9.75 | 11.25 | 9.75 |
| (% by weight, | | | | | | | | |
| dry basis) | | | | | | | | |
| Water | 47.93 | 48.02 | 48.23 | 48.42 | 48.06 | 48.28 | 48.46 | 48.34 |
| Unsalted | 15.44 | 14.39 | 12.26 | 10.13 | 14.14 | 12.12 | 10.09 | 11.98 |
| Butter | | | | | | | | |
| Cream | 15.00 | 15.00 | 14.99 | 14.98 | 15.00 | 14.99 | 14.97 | 14.98 |
| Cheese NZMP | | | | | | | | |
| Sugar | 11.00 | 10.99 | 10.99 | 10.98 | 10.99 | 10.99 | 10.97 | 10.98 |
| (sucrose) | | | | | | | | |
| Skim Milk | 2.00 | 2.03 | 2.10 | 2.14 | 2.38 | 2.24 | 2.10 | 2.30 |
| Powder | | | | | | | | |
| Gelatin | 1.00 | 1.00 | 1.00 | 1.00 | 1.00 | 1.00 | 1.00 | 1.00 |
| Emulsifying | 1.00 | 1.00 | 1.00 | 1.00 | 1.00 | 1.00 | 1.00 | 1.00 |
| salts: Joha C | | | | | | | | |
| Special | | | | | | | | |
| Lactic Acid | 0.43 | 0.50 | 0.52 | 0.60 | 0.50 | 0.53 | 0.65 | 0.62 |
| 80% | | | | | | | | |
| Carrageenan | 0.27 | 0.27 | 0.27 | 0.27 | 0.27 | 0.27 | 0.27 | 0.27 |
| (Gelcarin GP | | | | | | | | |
| 911) | | | | | | | | |
| Locust bean | 0.12 | 0.12 | 0.12 | 0.12 | 0.12 | 0.12 | 0.12 | 0.12 |
| gum (LBG) | | | | | | | | |
| Potassium | 0.05 | 0.05 | 0.05 | 0.05 | 0.05 | 0.05 | 0.05 | 0.05 |
| Sorbate | | | | | | | | |
| Composition | | | | | | | | |
| Moisture (% | 60.1 | 60.1 | 59.2 | 60.3 | 59.9 | 60.2 | 60.2 | 60.1 |
| by weight) | | | | | | | | |
| pH | 5.54 | 5.45 | 5.30 | 5.23 | 5.50 | 5.44 | 5.34 | 5.40 |
| Properties | | | | | | | | |
| of lollipops | | | | | | | | |
| In-process | As | Slightly | Much higher | Much higher | Slightly | Similar | Noticeably | Thin and |
| viscosity | expected | thicker | than 400. | than 400. | thicker | to 411 & | less thick | fluid |
| observation | | than 400. | Increase in | Would not | than 400. | 404 | than 403. | |
| | | Small increase | mixing | flow until | Small increase | | Thicker | |
| | | in mixing | speed | cook temp | in mixing | | than 404. | |
| | | speed | required to | reached. | speed | | | |
| | | required to | maintain | | required | | | |
| | | maintain | vortex. | | to maintain | | | |
| | | vortex. | | | vortex. | | | |
| Yield stress | 4140 ± 216 | 5640 ± 109 | 12175 ± 662 | 15950 ± 886 | 4500 ± 156 | 3640 ± 150 | 5660 ± 145 | 3440 ± 49 |
| (Pa) | | | | | | | | |
| Sensory | Tender, | Firmer | Firmer, | Much firmer | Slightly | Slightly | Firmer | Described, |
| | smooth, | and more | fudgy | than 400. | firmer | firmer | than 400. | as softer, |
| | creamy | grainy | texture, | Slightly | and more | than 400. | Dissolved | foamy |
| | flavour. | than 400. | less easy | brittle, | grainy | Significantly | slowly in | and light |
| | | | to dissolve | dissolved | than 400 | less firm | mouth. | texture |
| | | | in mouth, | poorly in | | than 402. | Flavour | compared |
| | | | less sweet, | mouth,had | | | slightly | to 400. |
| | | | less sour. | less overall | | | less sweet/ | Slightly sour/ |
| | | | Statistically | flavour and | | | cultured. | astringent |
| | | | significant | sweetness | | | Less firm | notes. |
| | | | difference | than 400. | | | than 403. | |
| | | | to 400. | Some protein | | | | |
| | | | | notes. | | | | |
| | | | | Statistically | | | | |
| | | | | significant | | | | |
| | | | | difference | | | | |
| | | | | to 400. | | | | |

### 14. Example 14

This example describes preparing an individually wrapped slice (IWS) of processed cheese comprising the milk protein composition of the invention.

Slices of IWS were prepared in a Thermomix cooker according to the following process:
1. Dry ingredients, butter and grated cheeses were weighed according to Table 17a (e.g. TSC, DSP, SMP, rennet casein, citric acid, potassium sorbate, salt). Grated cheeses were kept chilled.
2. Dry ingredients, butter and cheese ingredients were placed into a Magimix food processor bowl, and mixed using a metal blade, until the cheeses have been worked into a roughly homogeneous paste (approx. 30-60 sec).
3. The required water was weighed and added to the mixture in the food processor, and then processed until the mixture was lighter in colour and was a homogeneous paste (approx. 30-60 sec).
4. Cheese blend was transferred from Magimix bowl to Thermomix bowl.
5. 9 g water was added (per 1000 g batch) to account for moisture loss during cooking.
6. Thermomix temperature target was set to 95° C. and mixed until the material melted down to be glossy and smooth (all cheese has melted properly). During this time the mixing speed was adjusted manually (between speed 1-4) at different times to ensure adequate movement of product around the bowl.
7. When the mixture was melted to be glossy and smooth, pH was checked and adjusted with diluted citric acid to pH 5.70-5.75.
8. Heating continued and once temperature reached 87° C. (by manual measurement), the Thermomix temperature setting was reduced to 90° C. and product was mixed on speed 3-4, for 6 minutes.
9. While cooking, the slice-forming equipment and any other sample containers (Plastic IWS film, 3mm thick metal strips, marble rolling pin, sample containers) were prepared on the bench beside the Thermomix.
10 A portion of the hot mixture was poured or spooned onto polypropylene film, covered with another piece of film, and rolled flat into 3 mm thick slices using a rolling pin and metal strips to control thickness. This was repeated to give 2-3 slices.
11. Film-coated slices were placed onto pre-chilled metal trays, and then transferred to a chiller for further cooling. After 45 minutes, cooled slices from each batch were then collated and stored together in a zip-lock bag, and stored at 4° C.

TABLE 17
Composition of IWS

| Sample ID | 510 | 511 | 512 | 513 | 514 | 515 | 516 |
|---|---|---|---|---|---|---|---|
| MPC F | | 2.13 | 3.97 | 7.24 | | | |
| MPC 21, see Table 3 | | | | | 2.14 | 4.35 | 7.29 |
| Calculated Total | 16.5 | 18.1 | 19.8 | 21.9 | 18.1 | 19.8 | 21.9 |
| protein (% by | | | | | | | |
| weight, dry basis) | | | | | | | |
| Water | 26.11 | 26.29 | 26.57 | 26.74 | 26.35 | 26.62 | 26.95 |
| Cheddar (medium - | 21.99 | 21.98 | 21.97 | 21.96 | 21.97 | 21.96 | 21.95 |
| 5 months) | | | | | | | |
| Cheddar (frozen | 15.49 | 15.48 | 15.48 | 15.47 | 15.48 | 15.48 | 15.47 |
| young) | | | | | | | |
| Cheddar (40% fat in | 12.99 | 12.99 | 12.98 | 12.97 | 12.99 | 12.98 | 12.97 |
| dry matter, frozen) | | | | | | | |
| Unsalted Butter | 7.70 | 5.57 | 2.93 | 0.97 | 5.51 | 3.41 | 0.76 |
| Cheddar Mature | 8.00 | 7.99 | 7.99 | 7.98 | 7.99 | 7.99 | 7.98 |
| Trisodium Citrate | 2.50 | 2.50 | 2.50 | 2.50 | 2.50 | 2.50 | 2.49 |
| dihydrate | | | | | | | |
| Skim Milk Powder | 2.00 | 1.79 | 2.31 | 0.81 | 1.79 | 1.39 | 0.75 |
| Rennet Casein | 1.50 | 1.50 | 1.50 | 1.50 | 1.50 | 1.50 | 1.50 |
| Salt | 0.80 | 0.80 | 0.80 | 0.80 | 0.80 | 0.80 | 0.80 |
| Disodium phosphate | 0.60 | 0.60 | 0.60 | 0.60 | 0.60 | 0.60 | 0.60 |
| dihydrate | | | | | | | |
| Citric Acid | 0.31 | 0.36 | 0.39 | 0.45 | 0.36 | 0.41 | 0.46 |
| Potassium sorbate | 0.02 | 0.02 | 0.02 | 0.02 | 0.02 | 0.02 | 0.02 |

The samples were evaluated for:
in-process observation during cooking
firmness at 13° C. using TA-HD texture analyser 7 days after manufacture
melt test 7 days after manufacture
informal analysis by processed cheese experts 7-10 days after manufacture
Moisture using oven drying

Firmness of IWS was determined on a stack of 10 slices as described in section 7.

The melt test measures the melt and flow of the cheese:
Two 40 mm circles approximately 3 mm thick are cut from the stacked cheese samples used in the firmness testing. The circles are stacked and placed in the centre of a glass petri dish and covered with a glass lid.
The samples are conditioned at 4° C. for 10 minutes before being placed in the centre of a preheated conventional fan oven for 5 minutes at 232° C.
Once cooled, place the uncovered sample on a chart that measures the flow of the cheese in six directions. An average score of 0 indicates no flow in all six directions. The maximum score is 12, which indicates the sample flowed to the edge of the petri dish in all directions.
Average the six flow measurements and record as the melt score.

Moisture measurement of IWS:
Condition the moisture dishes by heating them in oven then cooling them in a dessicator.
Weigh approximately 10 to 10.5 g of the sample into a metal dish.
Heat it to 105° C. for 16 hours in a controlled oven/incubator.
Place the dried samples in a desiccator and allowed to cool.
Weigh the samples. The difference between the initial and final weight is assumed to be the moisture content of the cheese sample.

TABLE 18
Properties of IWS

| Sample ID | 510-A | 510-B | 511 | 512 |
|---|---|---|---|---|
| Moisture (% | 47.0 | 47.1 | 46.9 | 47.5 |
| w/w) | | | | |
| pH | 5.70 | 5.79 | 5.64 | 5.62 |
| In-process | Very thick. | Slightly | Very thick. | Very thick. |
| observation | Hard to pack | less thick, | Hard to pack | Hard to pack |
| | and form slices. | and slightly | and form slices. | and form slices. |
| | | easier to form | | Thickened |
| | | slices than 510-A. | | very quickly |
| | | | | while packing. |
| Firmness (N), | 6.13 ± 0.06 | 5.65 ± 0.09 | 8.63 ± 0.21 | 11.80 ± 0.24 |
| 95% CI | | | | |
| Melt score | 1.6 | 7.2 | 1.2 | 0 |
| Sensory | Firm, smooth, elastic. | Similar to | Slightly firmer | Slightly firmer |
| | Melts and coats mouth. | 510-A | than 510 A&B. | than 510 A&B, |
| | Milky, salty, cheesy. | | Possibly slower | and possibly |
| | Some metallic | | flavour release, | more dry/brittle. |
| | aftertaste. | | less salty and | Similar |
| | Typical but firm IWS. | | slight protein | flavour to 511 |
| | | | flavour (no | |
| | | | consensus) | |

| Sample ID | 513 | 514 | 515 | 516 |
|---|---|---|---|---|
| Moisture (% | 47.8 | 53.4 | 50.4 | 46.9 |
| w/w) | | | | |
| pH | 5.62 | 5.75 | 5.77 | 5.70 |
| In-process | Dough like | Similar | Slightly doughy | Dough like |
| observation | texture at start | to 510-A | at start of | texture at start |
| | of cooking. | | cooking. Similar | of cooking. |
| | Very difficult to | | viscosity to 510-A | Similar to 510-B |
| | form into slices | | at end of cook. | at end of cook. |
| | manually. | | | |
| Firmness (N), | 11.99 ± 0.26 | 6.95 ± 0.13 | 7.96 ± 0.36 | 9.49 ± 0.19 |
| 95% CI | | | | |
| Melt score | 0.9 | 5.8 | 3.6 | 7.4 |
| Sensory | Noticeably | Slightly firmer | Slightly firmer | Firmer than |
| | firmer than 510 | than 510 A&B, | than 510 A&B, | 510A&B. Less |
| | A&B. Brittle/dry. | otherwise similar | otherwise similar | firm than 513. |
| | Slow flavour | texture. Slower | texture. Similar | Slow flavour |
| | release. Protein | flavour release | texture to 514. | release. |
| | flavour more | and less salty | Slower flavour | Less salty and |
| | noticeable than | than 510A&B. | release and less | less “clean” |
| | 511 or 512. | Noted as “best | salty than 510 A&B. | flavour than 510 |
| | | overall flavour”. | Slight soapy or | A&B. Slight |
| | | | metallic notes. | protein flavour. |

It is not the intention to limit the scope of the invention to the abovementioned examples only. As would be appreciated by a skilled person in the art, many variations are possible without departing from the scope of the invention as set out in the appended claims.

### INDUSTRIAL APPLICATION

The milk protein composition described herein is useful for the production of low viscosity protein-containing food products, including acidified and fermented food products such as yoghurts and acid milk drinks.

1. A milk protein composition comprising a milk protein concentrate, a milk protein isolate or a combination thereof, wherein
a) the composition comprises at least about 40% by weight total protein relative to the dry matter in the composition,
b) the total milk protein comprises less than about 79% by weight of peptides having a molecular weight of greater than about 20 kDa, and
c) the composition comprises
i. less than about 2 g calcium per 100 g total protein, and/or
ii. less than about 1.4 g calcium per 100 g of the dry matter in the composition.

2.-40. (canceled)
